(19) United States
(12) Patent Application Publication
(10) Pub. No.: US 2015/0133022 A1
(43) Pub. Date: May 14, 2015

(54) PERIPHERAL APPARATUS FOR STORING AND POSITIONING A PORTABLE ELECTRONIC DEVICE

(71) Applicants: CARRIE USHIBA, MONTEREY, CA (US); JAMES USHIBA, MONTEREY, CA (US)

(72) Inventors: CARRIE USHIBA, MONTEREY, CA (US); JAMES USHIBA, MONTEREY, CA (US)

(21) Appl. No.: 14/479,376

(22) Filed: Sep. 8, 2014

Related U.S. Application Data
(63) Continuation-in-part of application No. 13/304,687, filed on Nov. 28, 2011, now Pat. No. 8,827,760.

(51) Int. Cl. A63H 3/00; A63H 3/04; F16M 13/00; A63H 3/02

(52) U.S. Cl. CPC A63H 3/003; A63H 3/02; A63H 3/04; F16M 13/00
USPC 446/73

(57) ABSTRACT

A device includes a first element coupled with a fabric and a second element coupled with an electronic device. It is essential that one of the two elements have a magnetic charge and that the other element be attractive to the magnetically charged element. The first element and the second element are magnetically attracted. The first element may be a magnet and/or comprise a ferromagnetic material, and the second element may be either (a.) present a magnet charge that is attractive to the first element and/or (b.) comprise a ferromagnetic material that is magnetically attracted to the first element. The fabric may be attached to or part of a plush toy, a plush toy adapted as a backpack, or a backpack with at least one strap

### CLAIM FOR PRIORITY

The present application is a continuation-in-part of currently pending U.S. patent application Ser. No. 13/304,687 titled PERIPHERAL APPARATUS FOR POSITIONING AND USING A PORTABLE ELECTRONIC DEVICE and filed on Nov. 28, 2011.

### FIELD OF THE INVENTION

The present invention relates to digital device peripheral equipment. More particularly, the present invention relates to method and devices for using and positioning an electronic video screen that renders digitally store images.

### BACKGROUND OF THE INVENTION

Portable electronic devices have become increasingly affordable to the average consumer. With widespread usage that compactness and lightness of conventional digital electronic devices provide, many children in particular have had increased access to such devices and have become accustomed to near constant access to digital media. Accordingly, many parents have developed a willingness to employ devices that render audio and/or video programs to entertain, educate and occupy the attention of their child or children. However, these devices tend to be expensive and leaving the management of such devices to a small child can be risky.

The prior art includes accessories for electronic devices that render audio and video files and which secure a portable media device. However, there remains an unmet need for a peripheral apparatus that is attractive to a child, can maintain, secure and position a portable media device, store the device, and further ease a child's use and enjoyment of such a device. In particular, the prior art fails to provide methods or devices that optimally support the maintenance and positioning of portable electronic devices that present video screens for rendering digital files that store representations of visual images.

Accordingly, it would be advantageous to provide an apparatus and method that addresses many of the problems that have not been solved by the conventional art and more optimally supports the use and secure positioning of an electronic video screen.

### SUMMARY OF THE INVENTION

It is an optional object of the present invention to provide a single peripheral to a portable media device which provides physical storage, and a means for easy presentation and display. It is an additional object of the present invention to provide the same peripheral with additional peripheral functions such as audio management.

Towards this object and other objects that will be made obvious in light of this disclosure, a first preferred configuration of the present invention includes a portable video device support structure encased within a stuffed toy, wherein at least one of the extremities of the structure of the toy allow a user to position a portable electronic device and the toy having an internal hollow shell capable of containing the portable electronic device. The portable electronic device may be enabled render digitized audio files and/or digitized video files. Various configurations of the invented toy may include a shell or case disposed between the portable device and the support structure; one or more audio speakers, e.g., directional audio speakers or headphones; and a module or element that provides electrical power to the portable video device.

According to alternate optional aspects of alternate preferred embodiments of the invented device, a first element as coupled with a fabric and a second element is coupled with an electronic device. The first element and the second element are magnetically attracted. One of the two elements have a magnetic charge and the other element is attractive to the magnetically charged element. The first element may carry a magnetic charge and/or comprise a ferromagnetic material, and the second element may be either (a.) present a magnetic charge that is attractive to the first element and/or (b.) comprise a ferromagnetic material that is magnetically attracted to the first element. The fabric may be attached to or be part of (a.) a plush toy, (b.) a plush toy adapted as a backpack, or (c.) a backpack with at least one strap.

Alternate preferred embodiments of the invented device may include an electric battery; one or more solar energy panels that charge the battery; an electric cord that enables charging the battery from a landline power socket; a device power cord that delivers electrical power from the battery to a device; ear buds that may couple with the portable electronic device; and one or more audio speakers that emit sound derived from the portable electronic device. The foregoing and other objects, features and advantages will be apparent from the following description of the preferred aspects of the invention as illustrated in the accompanying drawings.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

Such incorporations include U.S. Pat. No. D574,700, titled “Ball and socket connector” (Inventor: Bevirt, Joeben; Issued on Aug. 12, 2008); U.S. Pat. No. 7,891,615, titled “Mounting apparatus using ball and socket joints with gripping features” (Inventor: Bevirt, Joeben; Issued on Feb. 22, 2011); United States Patent Application Publication No. 20100078536, titled “Hands-free device holder for securing hand-held portable electronic device with a screen” (Inventor: Galvin, Nicolette A.; Published on Apr. 1, 2010); United States Patent Application Publication No. 20070253580, titled “Carrying bag and portable comfort pillow having two headphone speakers thereon connected to a headset carrying” strap” (Inventor: Sutton, Joseph A.; Published on Nov. 1, 2007); and United States Patent Application Publication No. 20070253581, titled “Toy in the form of a stuffed toy or 3-D character toy having a headset carrying strap with two headphone speakers and an audio player built into one of the speakers” (Inventor: Sutton, Joseph A.; Published on Nov. 1, 2007).

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

FIG. 1A presents a first version of the invented device coupled with and positioning an phone;

FIG. 1B provides a second version of the invented device further comprising a battery, a power cord to a phone, pair of ear buds, an audio speaker at each foot pad, and solar panels;

FIG. 1C illustrates the second version of the invented device of FIG. 1B further comprising a protective device shell, a suction cup and an elastic band for maintaining the phone in a position;

FIG. 2 is a detailed exposed view of an articulating skeleton of the first version of FIG. 1A and the second version of FIG. 1B;

FIG. 3 provides a detailed view of the battery, the power cord to the phone; the pair of ear buds; the audio speakers and the solar panels of the second version of FIG. 1B;

FIG. 4 is a cut away view of the second version of FIG. 2 and showing the electrical elements of FIG. 1B and FIG. 3;

FIG. 5 is cut away view of iPhone attached to the battery of FIG. 3 and FIG. 5 coupled with the phone of FIGS. 1A, 1B, 2 and 4;

FIG. 6 is a detailed sectional view of U-shaped gripping elements for the phone of FIG. 1A, FIG. 1B and FIG. 2;

FIG. 7 is an external view of an alternate embodiment of the second version of FIG. 1B, wherein the phone is coupled with the second version by four triangular-shaped corner connectors;

FIG. 8 is a detailed cut-away side view of the alternate embodiment of the second version of FIG. 7 showing one of the four triangular-shaped corner connectors;

FIG. 9 is a cut-away side view of the alternate embodiment of the second version of FIG. 7 showing the four triangular-shaped corner connectors, an external high friction surface, and a weighted bag;

FIG. 10 is a top view of one of the four triangular-shaped corner connectors of FIG. 7;

FIG. 11 is an isometric view of the second version of FIG. 1B detachably coupled a carrying strap;

FIG. 12A is a side view of a first embodiment of the invented body and arms structure;

FIG. 12B is a front view of a first embodiment of the invented body and arms structure;

FIG. 12C is a top view of a first embodiment of the invented body and arms structure;

FIG. 12D is a back view of a first embodiment of the invented body and arms structure;

FIG. 13A is a side view of a second embodiment of the invented body and arms structure;

FIG. 13B is a front view of a second embodiment of the invented body and arms structure;

FIG. 13C is a top view of a second embodiment of the invented body and arms structure;

FIG. 13D is a back view of a second embodiment of the invented body and arms structure;

FIG. 14A is a side view of a first embodiment of the invented body and arms both storing and displaying a portable media device;

FIG. 14B is a front of a first embodiment of the invented body and arms both storing and displaying a portable media device;

FIG. 15 is a close-up view of a removable arm of the invented body;

FIG. 16A is a side view of a third, two-arm embodiment of the invented body and arms both storing and displaying a portable media device;

FIG. 16B is a front view of a third, two-arm embodiment of the invented body and arms both storing and displaying a portable media device;

FIG. 17A is a front view of a fourth embodiment of the presently invented body and arms;

FIG. 17B is a side view of a fourth embodiment of the presently invented body and arms;

FIG. 17C is a side view with closed clamps of a fourth embodiment of the presently invented body and arms;

FIG. 17D is a top view with open camps of a fourth embodiment of the presently invented body and arms;

FIG. 17E is a top view with closed clamps of a fourth embodiment of the presently invented body and arms;

FIG. 18 is a side, cut-away view of a fifth embodiment of the invented toy;

FIG. 19A is a front view of the invented toy of FIG. 18 further including additional peripheral ear phones;

FIG. 19B is a side, cut-away view of the invented toy of FIG. 18 including additional peripheral ear phones;

FIG. 20A is a front view of the invented toy of FIG. 18 utilizing 4 arms to display a portable media device;

FIG. 20B is a front view of the invented toy utilizing of FIG. 18 arms to display a portable media device on its side;

FIG. 21A is a front view of the invented toy of FIG. 18 utilizing two arms to display a portable media device;

FIG. 21B is a front view of the invented toy of FIG. 18 utilizing two arms to display a portable media device on its side;

FIG. 22A is a front view of the invented toy of FIG. 18 including customizable, arm mittens;

FIG. 22B is a side view of the invented toy of FIG. 18 including customizable, arm mittens;

FIG. 23 is a side view of an alternate plush toy that encapsulates a magnetic plate;

FIG. 24 is a side view of the alternate plush toy of FIG. 23 showing the phone of FIG. 1, wherein a ferromagnetic material is affixed to the phone;

FIG. 25 is a front view of the phone and toy combination of FIG. 24,

FIG. 26A is a cut-away side view of the alternate plush toy of FIG. 23 showing the phone of FIG. 1, wherein the ferromagnetic material of FIG. 23 is affixed to the phone;

FIG. 26B is a detailed exploded view of the magnetic plate, two fasteners and section of fabric of FIG. 26A;

FIG. 26C is a detailed cut-away view of the of the magnetic plate and section of fabric coupled by the two fasteners of FIG. 26A piercing through the fabric and forming a friction fit with the magnetic plate;

FIG. 27 is an exploded view perspective view of the phone of FIG. 1, the magnetic plate, two fasteners, section of fabric of FIG. 26A and an external section of fabric positioned between the section of fabric of FIG. 26A and a ferromagnetic material;

FIG. 28 is a cut-away side view an alternate variation of the present, wherein an alternate magnetic plate is affixed to the phone of FIG. 1 and the plush toy of FIG. 23 encapsulates an alternate material, wherein the alternate material may be ferromagnetic and/or hold a charge that is attractive to the alternate magnetic plate;

FIG. 29 is a side view of a backpack that includes components of FIG. 27 and/or FIG. 28.

FIG. 30 is a cut-away side view of the backpack of FIG. 29 coupled with the phone of FIG. 4 by the components of FIG. 27;

FIG. 31 is a detailed view of a sheet of nanosuction material;

FIG. 32 is a side view of the nanosuction material adhered to the phone of FIG. 1 and removably coupled to a modification of the back pack of FIG. 29;

FIG. 33 is a perspective front view of the backpack of FIG. 32 removably coupled with the phone of FIG. 1; and

FIG. 34 is a perspective front view of the backpack of FIG. 30 and removably coupled with the phone of FIG. 1 and indicating the range of positions possible in removably coupling the phone with the backpack as made possible by each of the preferred embodiments of the present invention of FIGS. 28, 29 and 32.

### DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely”, “only” and the like in connection with the recitation of claim elements, or use of a “negative” limitation.

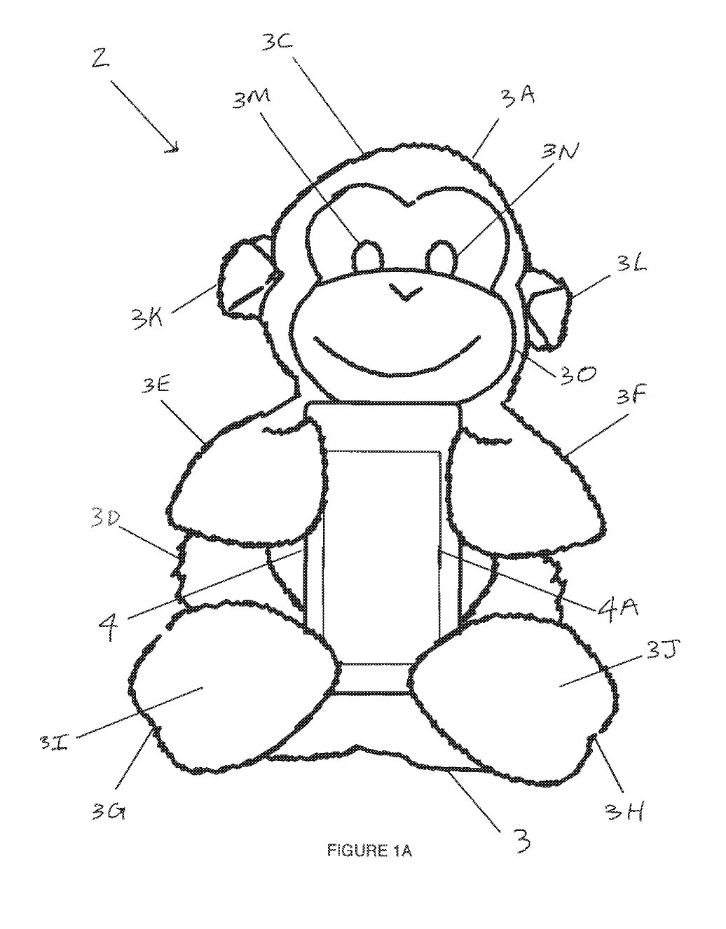

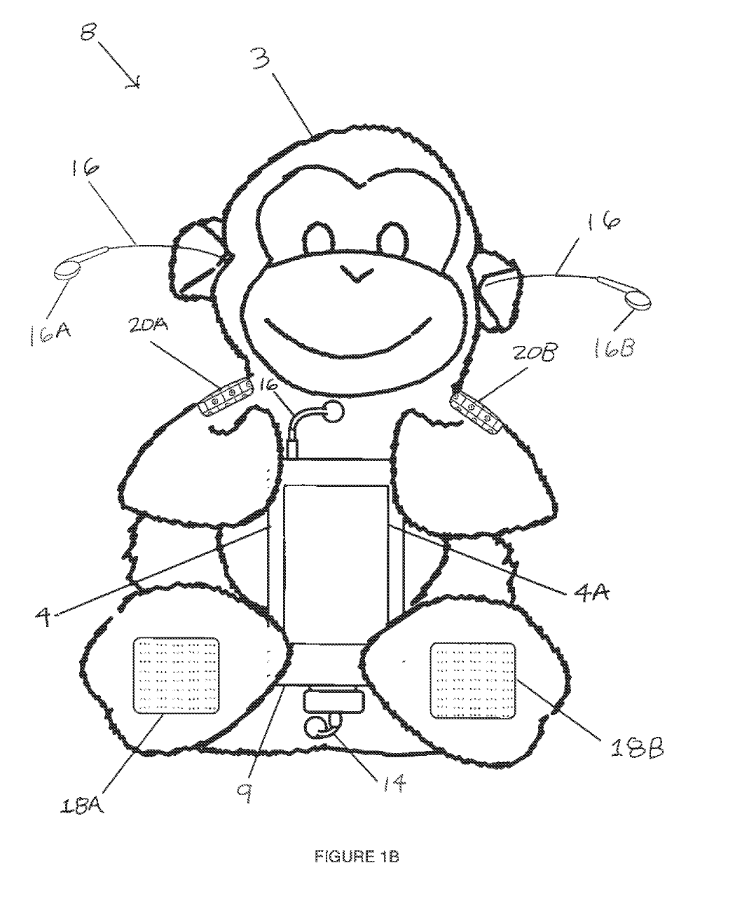

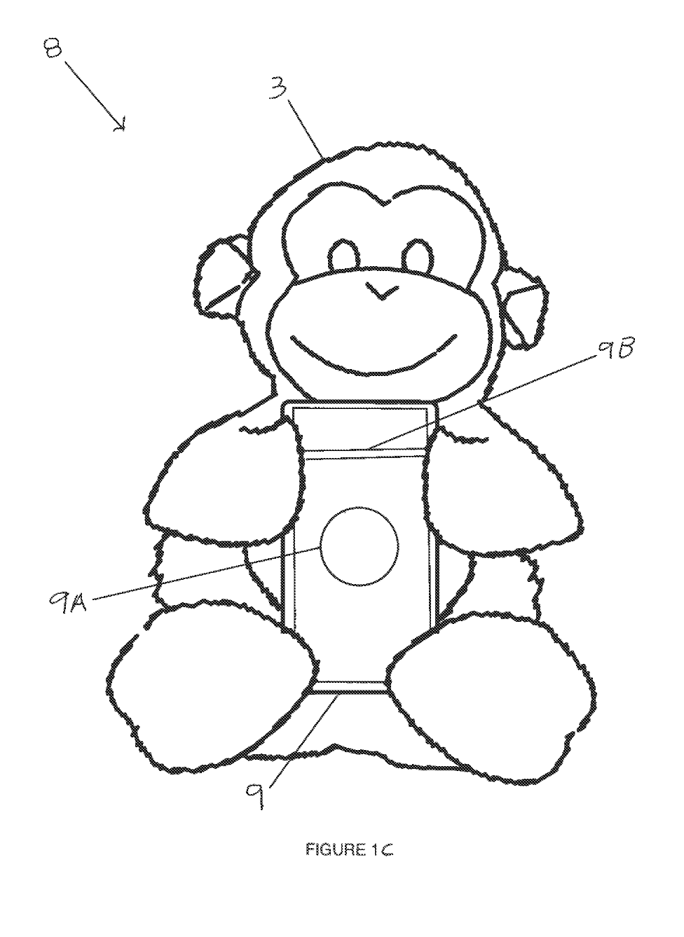

Referring now to FIG. 1A, FIG. 1A presents an exemplary first version 2 of the invented device having a figurine, wherein the first version 2 is coupled with and is applied by a user to position a cellular telephone 4 (hereinafter “phone” 4). The phone 4 may be or comprise (a.) a digital content player having a video screen 4A, such as an iPOD TOUCH 4G™ digital video display device as marketed by Apple, Inc. of Cupertino, Calif., (b.) a digital cellular telephone having a video display capability, such as an iPHONE 4S™ digital cellular telephone as marketed by Apple, Inc. of Cupertino, Calif., (c.) a MOTOROLA DROID X™ smart phone as marketed by Motorola Solutions, Inc. of Schaumberg, Ill., (d.) a MOTOROLA DROID X™ tablet computer as marketed by Motorola Solutions, Inc. of Schaumberg, IL; an iPAD™ tablet computer as marketed by Apple, Inc. of Cupertino, Calif.; and/or (f.) other suitable digital video display device, video-enabled telephone and/or tablet computer known in the art. While the first version 2 is described herein as adapted for holding and positioning an iPHONE™ cellular telephone, it is understood that the alternate versions of the invented apparatus may be adapted, sized and shaped to hold one or more various alternate electronic devices, such as a suitable alternate tablet computer, a cellular phone, and/or a personal digital assistant known in the art.

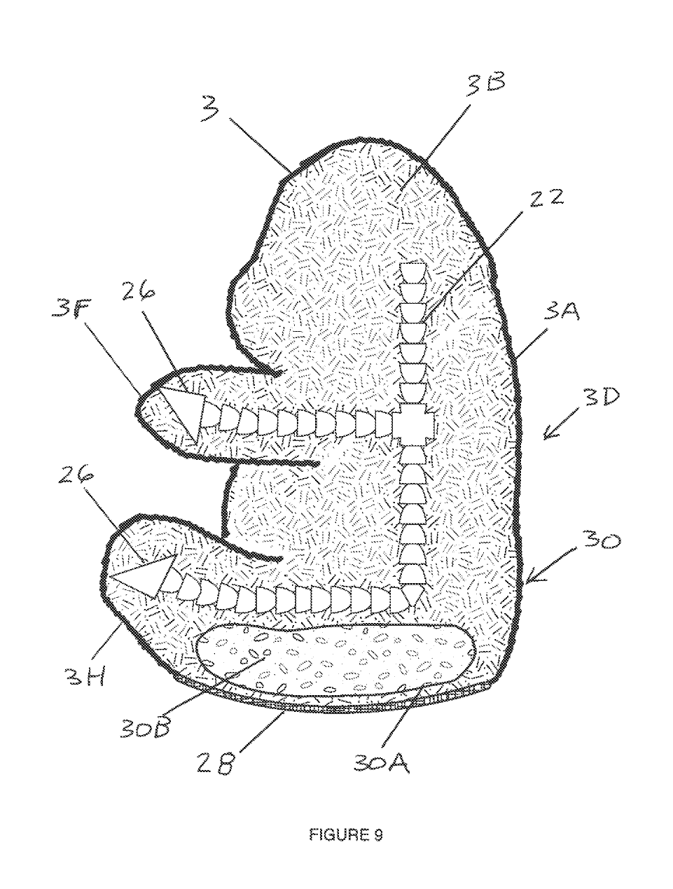

The first version 2 includes the three-dimensional figurine 3 made with a generally soft exterior fabric 3A, e.g., cotton, wool, rayon, or other suitable organic or inorganic material, and a internal stuffing 3B as shown in FIG. 9. The internal stuffing 3B may be or comprise cotton, cotton batting, wool, and/or other suitable organic, inorganic or synthetic material known in the art.

The shape of the figurine 3 defines a head region 3C, a body region 3D and two individual arm appendages 3E & 3F, and two individual leg appendages 3G & 3H. The two individual leg appendages 3G & 3H each include a separate footpad representation element 31 & 3J. The head region 3C presents two ear representation elements 3K & 3L, two eye representation elements 3M & 3N, and a snout representation element 30. The first version 2 further includes the stuffing 3B that maintains the volume of at least the head region 3C, the body region 3D and the representative limb regions 3E, 3F, 3G & 3H. One or more of the limb regions 3E, 3F, 3G & 3H are adapted to secure the figurine 3 to an external object (not shown).

The stuffing 3B is positioned within the exterior fabric 2A and may be or comprise a soft material, e.g., cotton, wool, rayon, or other suitable organic, inorganic or synthetic material.

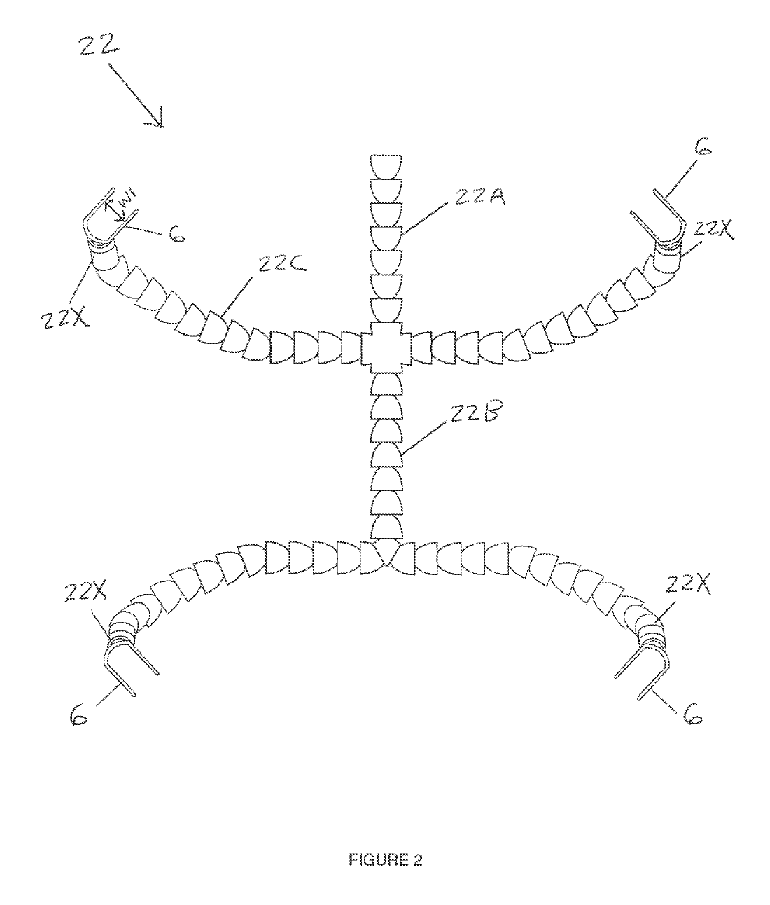

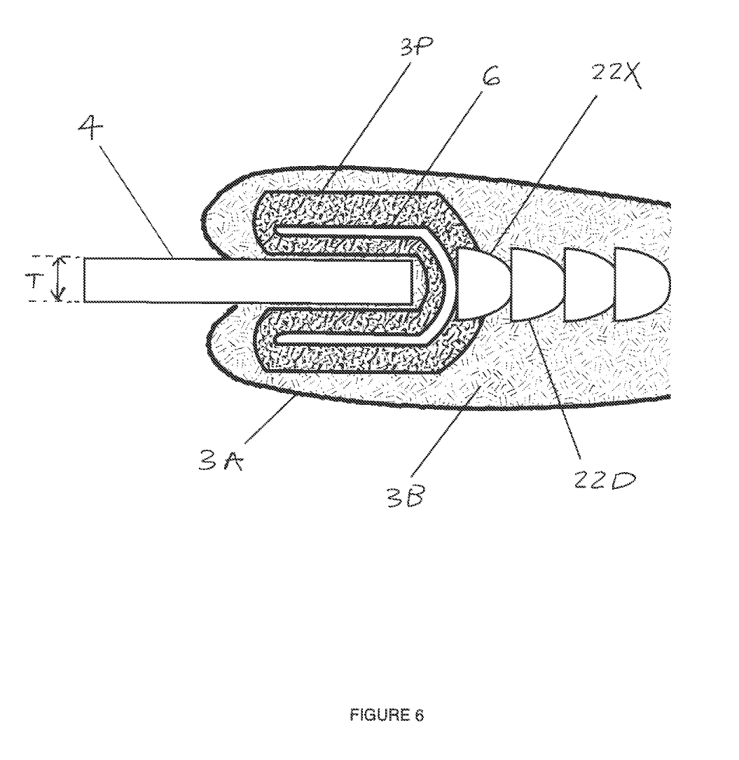

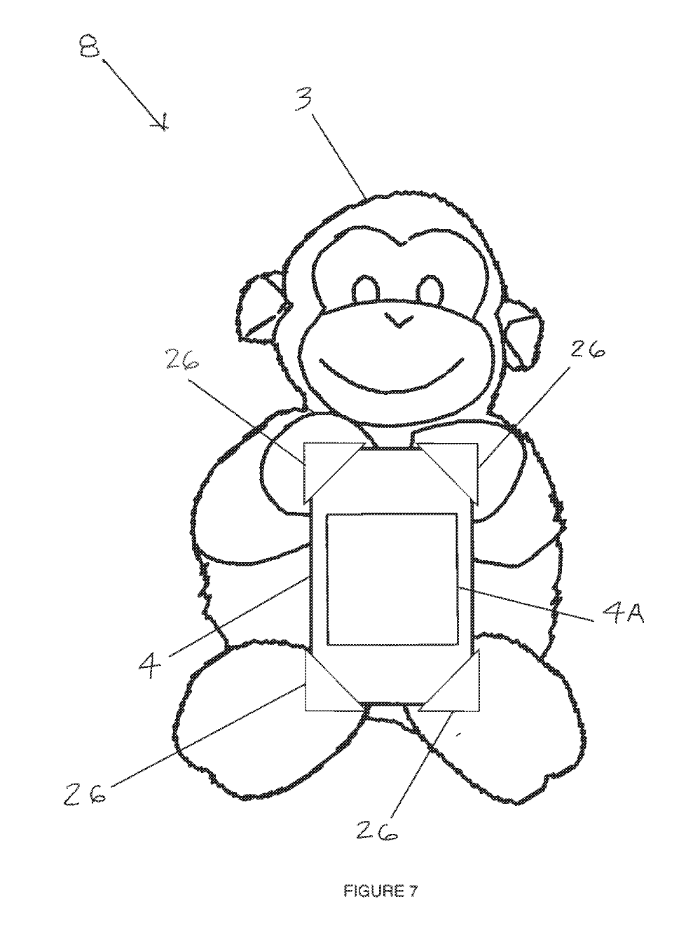

The phone 4 is secured and coupled to the figurine 2 by (a.) one or more U-shaped gripping elements 6 as presented more particularly in FIG. 2 and FIG. 6; (b.) one or more corner shaped gripping elements 8 as shown in FIGS. 7, 8, 9 and 10; and/or (c.) a friction fit protective device shell 9, i.e., a protective case 9 of FIG. 1B.

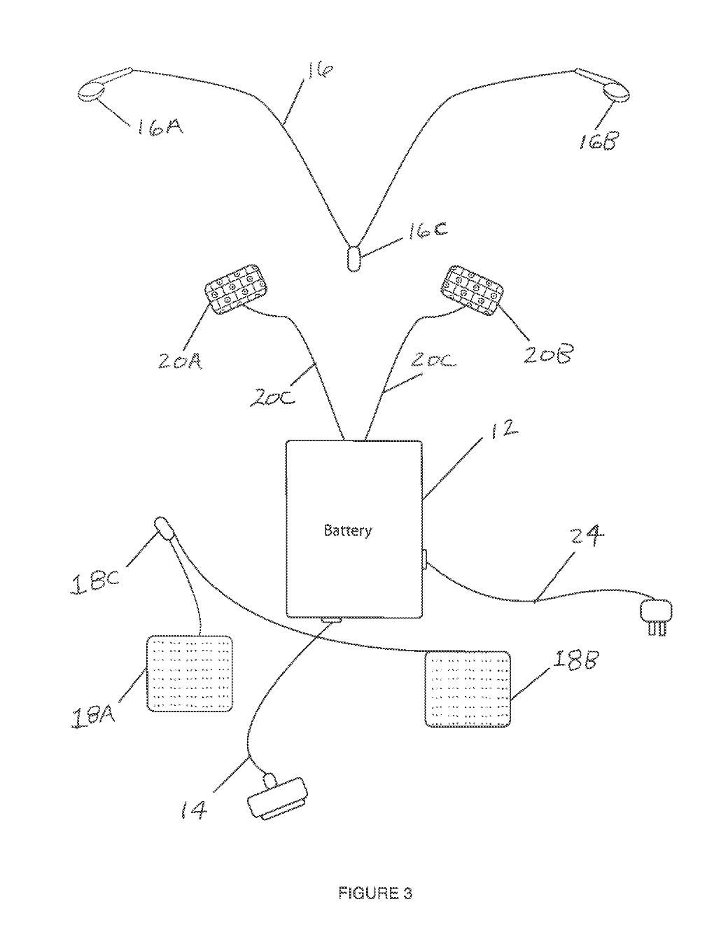

FIG. 1B is an external view a second version 8 of the invented device further comprising an enclosed battery 12 (as shown in FIGS. 3 through 5), a power cord 14 leading from the battery 12 and to the phone 4; an audio signal cabling 16 that includes a pair of ear buds 16A & 16B; two separate audio speakers 18A & 18B individually at each foot pad 3I & 3J; and a pair of solar panels 20A & 20B. It is understood that one or both audio speakers 18A & 18B may be directional speakers that generate sound waves having greater intensity along a single axis extending from the emitting speaker 18A or 18B.

The phone 4 is inserted into the friction fit protective device shell 9 and the friction fit protective device shell 9 is disposed in between the phone 4 one or more U-shaped gripping elements 6 and/or one or more corner shaped gripping elements 8. Where the phone 4 is an iPHONE 4S™ cellular telephone, the friction fit protective device shell 9 may be a FEATHER™ friction fit cover as marketed by Incipio Technologies of Irvine, Calif., or other suitable iPHONE™ cellular telephone case or cover known on the art. Alternatively, where the phone 4 is an iPOD 4G TOUCH™ video display device, the friction fit protective device shell 9 may be a DERMASHOT™ case as marketed by INCIPIO Technologies of Irvine, Calif., or other suitable iPOD™ video display device case or cover known on the art. Still alternatively, where the phone 4 is a tablet computer, or other video display device or video-enabled cellular telephone, the protective device case 9 may be adapted to snugly fit around the phone 4 and without substantively reducing visibility of the video screen 4A of the phone 4 of a user or observer. In one exemplary embodiment of the present invention, the second version 8 is adapted to hold an iPAD™ tablet computer and the protective device shell 9 is an iPAD SMART COVER™ protective case as marketed by Apple, Inc. of Cupertino, Calif..

FIG. 1C illustrates the second version 8 further showing the friction fit shell 8A, and further comprising an optional suction cup 9A and an optional elastic band 9B. The suction cup 9A and the elastic band 9B are attached to the protective device shell 9. The protective device shell 9 is adapted to accept the phone 4 and maintain the phone 4 under compression and within a friction fit. In the exemplary instance where the phone 4 is an iPHONE 4S™ , the protective device shell 9 may be an IPH-620 DELTA HARDSHELL CASE™ as marketed by Incipio Technologies of Irvine, Calif. It is understood that the phone 4 defines (a.) a front face on which the video display screen 4A is presented, and (b.) an opposite back face. The suction cup 9A is affixed to and positioned on the protective device shell 9 and is further adapted to apply suction force against the device back face to maintain the phone 4 within the protective device shell 9. The elastic band 9B is adapted to cross over the device front face to maintain the phone 4 within the protective device shell 9 and without obstructing a user's view of the video screen 4A.

FIG. 2 is a detailed exposed view of an articulating skeleton 22 of the first version 2 of FIG. 1A and the second version 8 of FIG. 1B. The skeleton 22 is formed with articulated components 22A-22X. One or more articulated components 22A-22X may be or comprise, or be selected from, suitable articulated elements known in the art, to include the ball and socket connector disclosed in U.S. Pat. No. 7,891,615 as a connecter. Alternately, optionally or additionally, one or more components 22A-22X may embody the connector design as disclosed in U.S. Pat. No. D574,700. The skeleton 22 in combination with two or more U-shaped gripping elements 6 and/or one or more corner shaped gripping elements 8 preferably enables the user to position the phone 4 about at least two axes of rotational motion and along at least two axes of linear motion, and more preferably within six degrees of motion, i.e., about at least three mutually orthogonal axes of rotational motion and linearly along the three mutually orthogonal axes.

In some embodiments, surfaces of one or more components 22A-22X may be coated with an adhesive. With some connector materials that may be comprised within one or more components 22A-22X, such as acetyl materials, Delrin, and Nylon, compounds normally used as adhesive may function as a lubricant when used in an interference fit ball and socket joint connector version of one or more components 22A-22X.

The U-shaped gripping elements 6 are shown in FIG. 2 to each be connected to a separate end articulated components 22X. Each U-shaped gripping element 6 is sized and shaped to receive the phone 4 and form a friction fit to enable the phone 4 to be gripped within one or more U-shaped gripping elements 6 while a user manually positions the skeleton 22 within three dimensional space by articulation of one or more of the articulated components 22A-22X. More particularly a U-width W1 of each U-shaped gripping elements 6 is made to be narrower that a thickness T of the phone 4, wherein the U-width W1 is preferably in the range of 0.001 inch to 0.2 inch narrower than the phone thickness T. Each U-shaped gripping element 6 may be or comprise a flexible metal or plastic, such as aluminum, Delrin, and Nylon, or other suitable material known in the art that will support the phone 4 in a static position, and preferably maintain the phone 4 under compressive force.

FIG. 3 provides a detailed view of elements of the second version 8 showing unobstructed front views of the battery 12, the electrically conductive phone power cord 14, the audio signal cabling 16, the audio speakers 18A & 18B, the solar panels 20A & 20B, and an electrically conductive external battery cord 24. The solar panels 20A & 20B, the phone power cord 14 and the external battery cord 24 are all shown in FIG. 3 in electrical connection to the battery 12. The solar panels 20A & 20B collect solar energy and transform the collected solar energy into electric energy. The solar panels 20A & 20B are coupled by transfer cabling 20C to the battery 12 and thereby provide electrical energy to the battery 12. The phone power cord 14 is sized and adapted to transfer electrical power from the battery 12 and to the phone 4. The optionally removable external battery cord 22 is sized and adapted to transfer electrical energy from an electrical power source socket (not shown) of, or electrically coupled to, (a.) a landline electrical power source (not shown), (b.) an electrical power generator (not shown), (c.) an external electrical battery (not shown), (d.) and/or other suitable sources of electrical energy known in the art.

The earphone audio signal cabling 16 is configured for coupling with the phone 4 and is therefore shown in FIG. 3 as being unattached to any other electrical element of the second version 8. An earphone connector 16C is sized and adapted for insertion into an audio channel socket of the phone 4. Additionally or optionally, a speaker cabling 18C electrically couples each of the two speakers 18A & 18B to a speaker connector 18D. The speaker connector 18D is sized and adapted for insertion into the audio channel socket of the phone 4.

In one exemplary embodiment of the second version 8 and/or the first version 2, where the second version 8 is adapted to couple with an iPHONE 4S™ cellular telephone as marketed by Apple, Inc. of Cupertino, Calif., the earphone audio signal cabling 16 may be or comprise APPLE iPOD EARPHONES™ as marketed by Apple, Inc. of Cupertino, Calif. In the exemplary embodiment of the second version 8 and/or the first version 2, where the second version 8 is adapted to couple with an iPHONE 4S™ cellular telephone as marketed by Apple, Inc. of Cupertino, Calif., the phone power cord 14 may be or comprise APPLE DOCK CONNECTOR TO USN CABLE™ as marketed by Apple, Inc. of Cupertino, Calif.

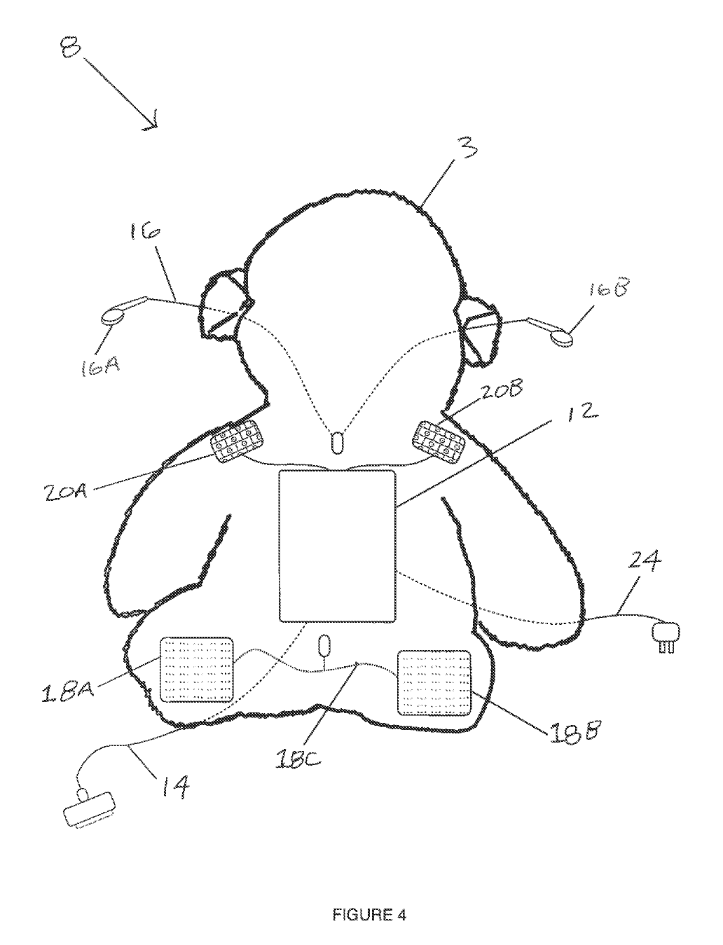

FIG. 4 is a cut away view of the second version of FIG. 2 and showing the components of FIG. 1B and FIG. 3 in place within the second version 8. The solar panels 20A & 20B, the phone 4 and the external battery cord 22 are all shown in FIG. 3 in electrical connection to the battery 12. The earphones audio signal cabling 18 and the speakers 18A & 18B are configured for coupling with the phone 4 and are therefore shown in FIG. 3 as being unattached to the battery 12 any other electrical element of the second version 8.

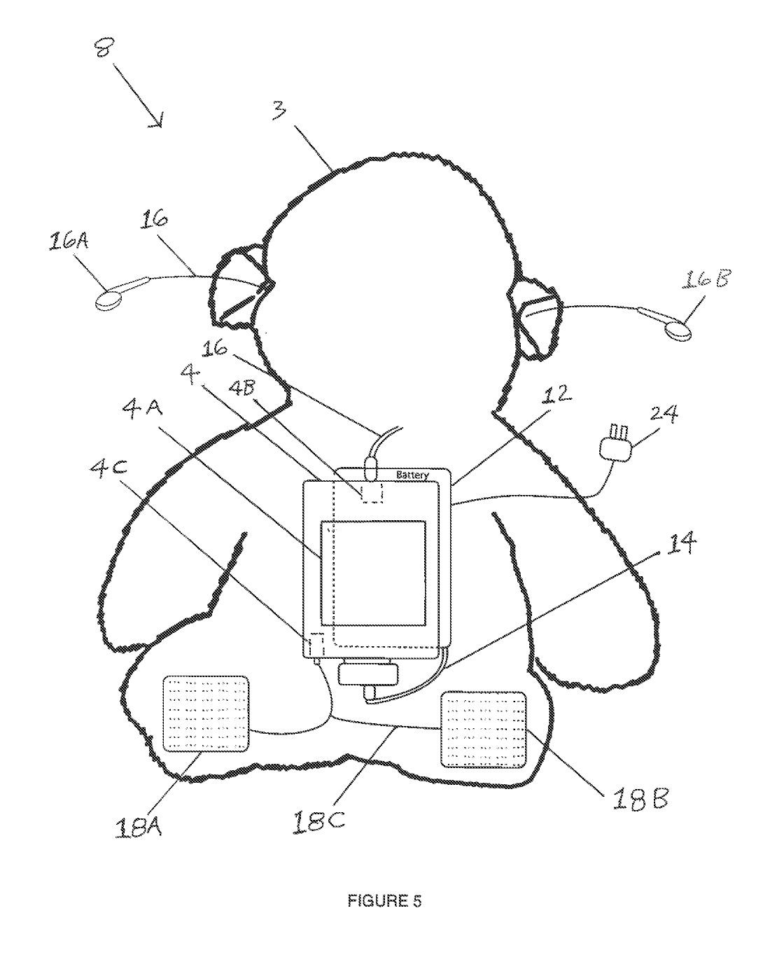

FIG. 5 is cut away view of the phone 4 electrically coupled to both the battery 12 and the earphone audio signal cabling 16. The phone 2 is electrically coupled to both the battery 12 and the phone 4 and transfers electrical power from the battery 12 and to the phone 4 in the configuration of FIG. 5. More particularly, the earphone connector 16C is shown to be electrically coupled with an audio channel socket 4B of the phone 4. For the purposes of illustration, the speaker connector 18D is simultaneously indicated in FIG. 5 to be electrically coupled to a second audio output socket 4C of the phone 4. It is understood that where the phone 4 has only one audio output socket 4B, that the simultaneous electrical connection of the earphone connector 16C and the speaker connector 18D is not enabled by the first version 2 or the second version 8.

FIG. 6 is a detailed sectional view of one of the U-shaped gripping elements 6 of the skeleton 22. The U-shaped gripping element 6 is attached to a last articulating element of the skeleton 22, and is optionally at least partially layered with an elastic layer 3P of the first version 2 that accepts the phone 4 and preferably applies compressive pressure against the phone 4 to retain the phone 4 within the U-shaped element 6.

FIG. 7 is an external view of an alternate embodiment of the second version 8, wherein the phone 4 is coupled with the second version 8 by four triangular-shaped corner connectors 26. Each corner connector 26 is separately attached to a unique end connector 22X of the skeleton 22. In certain alternate preferred embodiments of the present invention, the protective device shell 9 is preferably simultaneously positioned within two or more U-shaped gripping elements 6 and/or two or more corner shaped gripping elements 26.

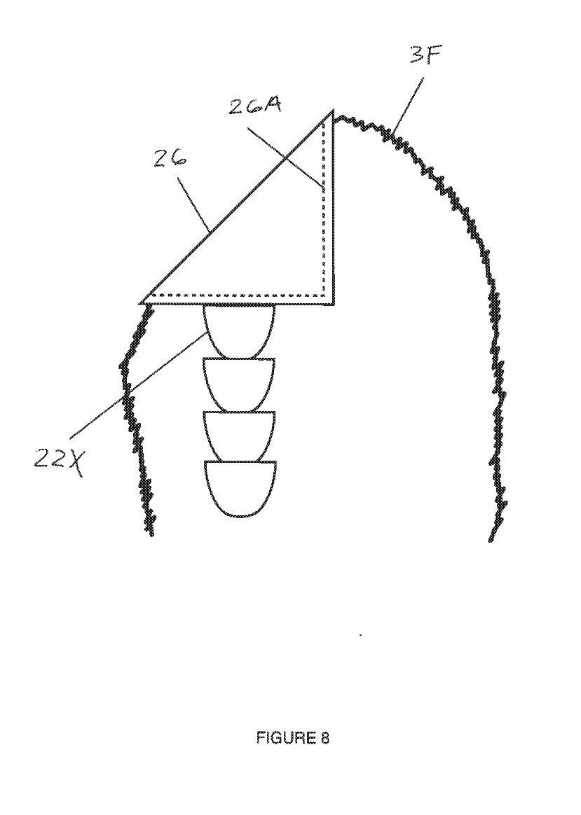

FIG. 8 is a detailed cut-away side view of the alternate embodiment of the second version 8 showing one of the four triangular-shaped corner connectors 26. A dotted line imposed within the representation of the corner connector 26 indicates a corner cavity 26A into which a corner of the phone 4 may be inserted. The exemplary corner connector is adhered or affixed to an end articulated component 22X.

FIG. 9 is a cut-away side view of the alternate embodiment of the second version 8 showing the four triangular-shaped corner connectors 26, an external high friction surface 28, and a weighted bag 30. The high friction surface 28 is adapted to resist a sliding of the second version 8 along a smooth surface (not shown). The high friction surface 28 may be sown, adhered and/or otherwise coupled to an outer side of the exterior fabric 3A.

The weighted bag 30 is adapted to support the second version 8 in an upright position, wherein the head region 3C is maintained above the body region 3D, the two individual arm appendages 3E & 3F, and the two individual leg appendages 3G & 3H. The weighted bag 30 includes a bag fabric 30A that encompasses a dense material 30B and is shaped and adapted to maintain the dense material 30B in a combined mass and in isolation from the internal stuffing 3B. The bag fabric 30A may be composed of cotton, nylon, or other suitable organic, inorganic or synthetic material known in the art that may be adapted to maintain the dense material 30B in a single, combined mass.

The dense material 30B is preferably at least twice as dense as either the skeleton 22 and the internal stuffing 3A, and more preferably greater than ten times as dense than either the skeleton 22 and the internal stuffing 3A. The dense material 30B may comprise sand, glass, plastic, glass beads, or other suitable organic, inorganic or synthetic material known in the art.

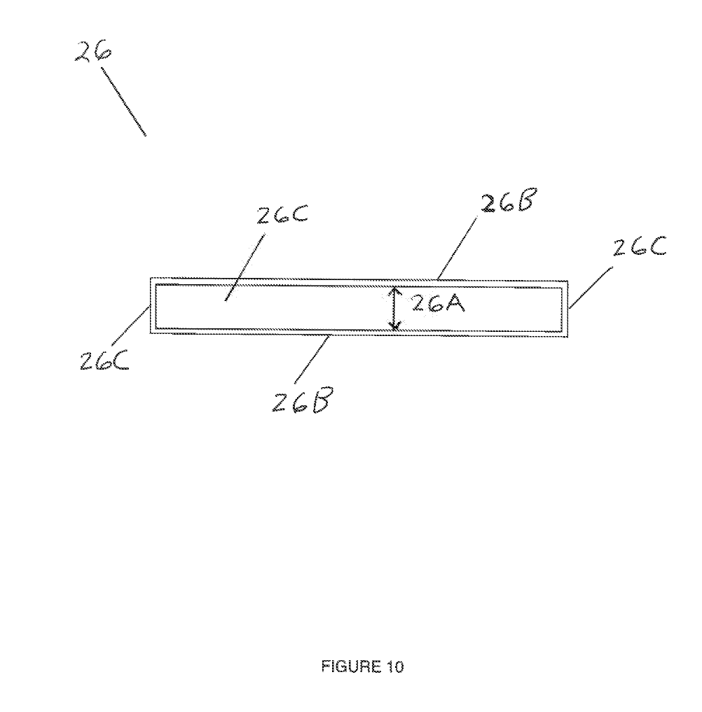

FIG. 10 is a top view of one of the four triangular-shaped corner connectors 26. A pair of triangular walls 26B are joined with a pair of rectangular walls 26C to form the corner cavity 26A. The corner cavity 26A preferably presents a cavity width W2 that is narrower that the thickness T of the phone 4. The cavity width W2 is preferably in the range of 0.001 inch to 0.2 inch narrower than the phone thickness T. One or more triangular-shaped corner connector 26 may be or comprise a flexible metal or plastic, such as aluminum, Delrin, and Nylon, or other suitable material known in the art that can be adapted to hold the phone 4, and preferably maintain the phone 4 under compressive force.

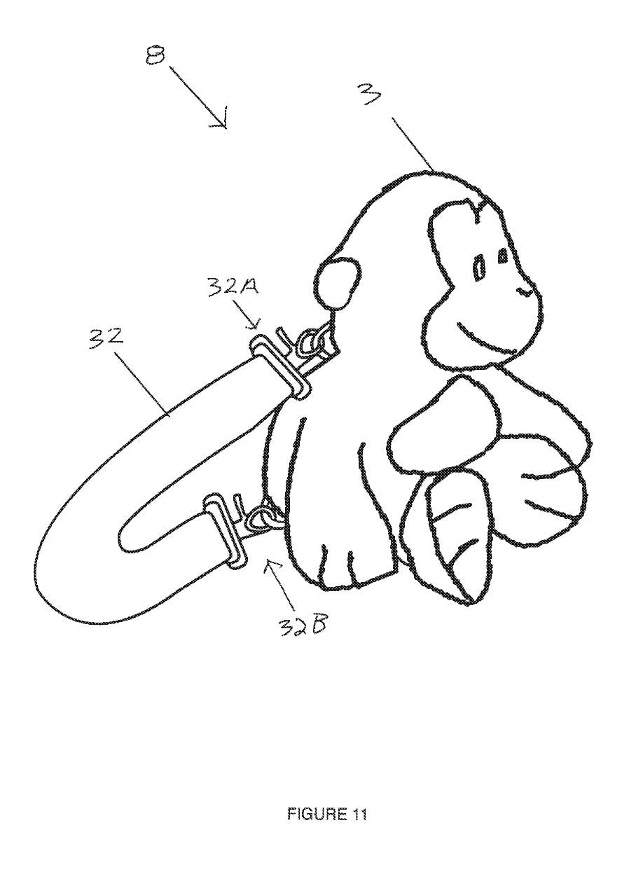

FIG. 11 is an isometric view of the second version 8 further coupled a carrying strap 32. A pair of detachable attachment assemblies 32A & 32B enable a user to alternately attach and detach the carrying strap 32 from the second version 8. The strap 32 may be made from canvas, nylon, cotton, or other suitable flexible strapping material. The pair of detachable attachment assemblies 32A & 32B may be made of a metal, metal alloy, plastic, or other suitable attachment assembly materials known in the art.

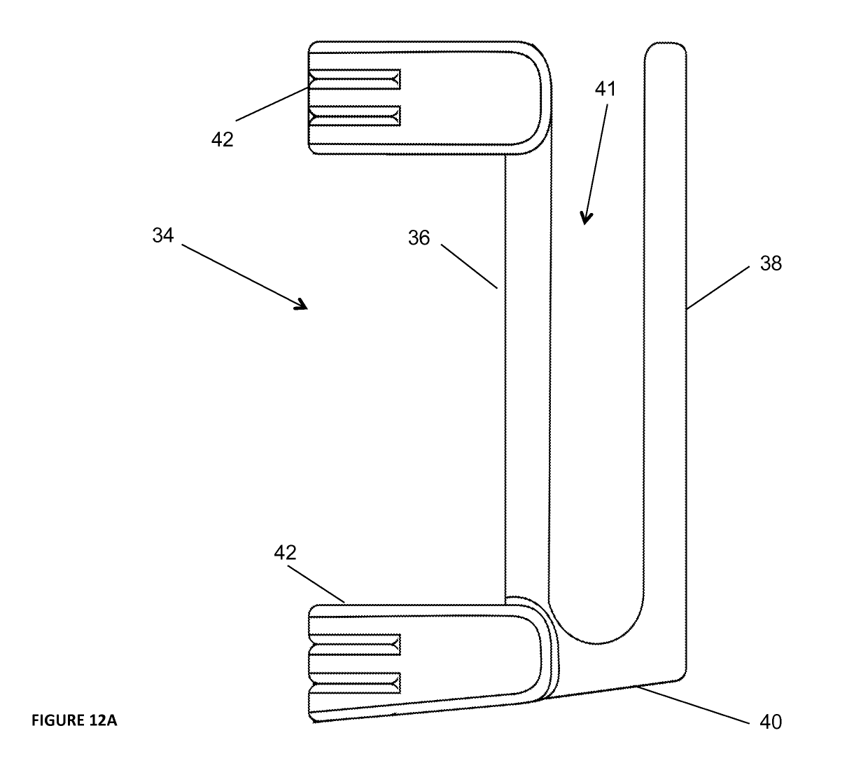

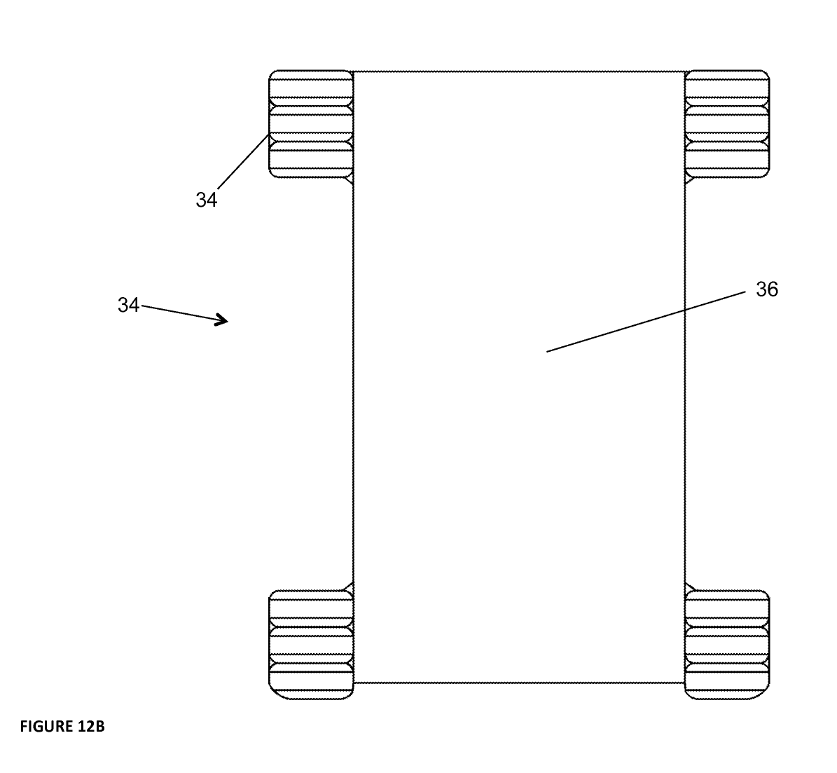

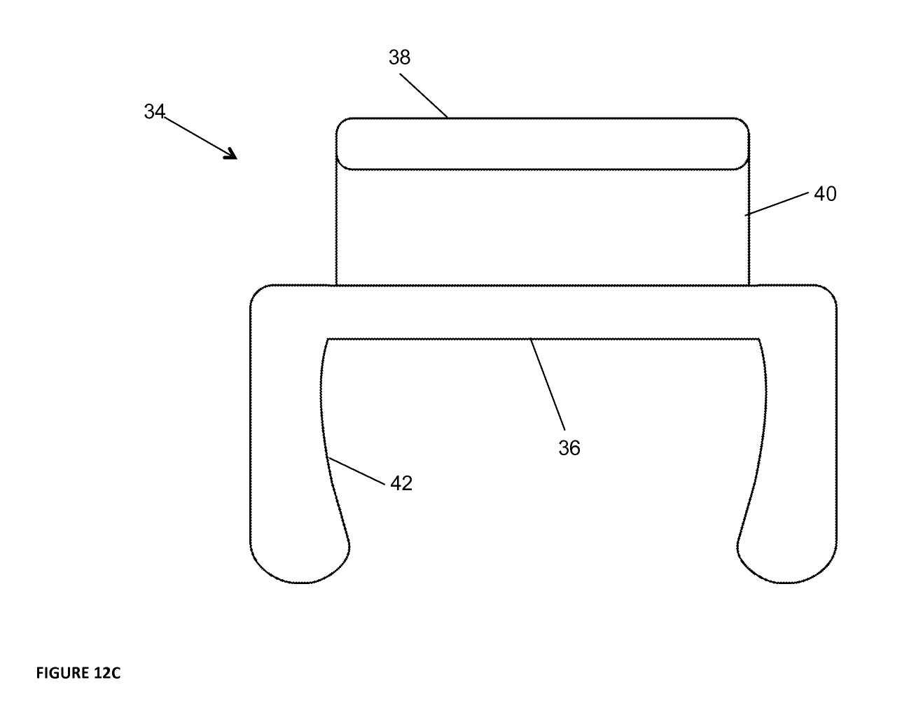

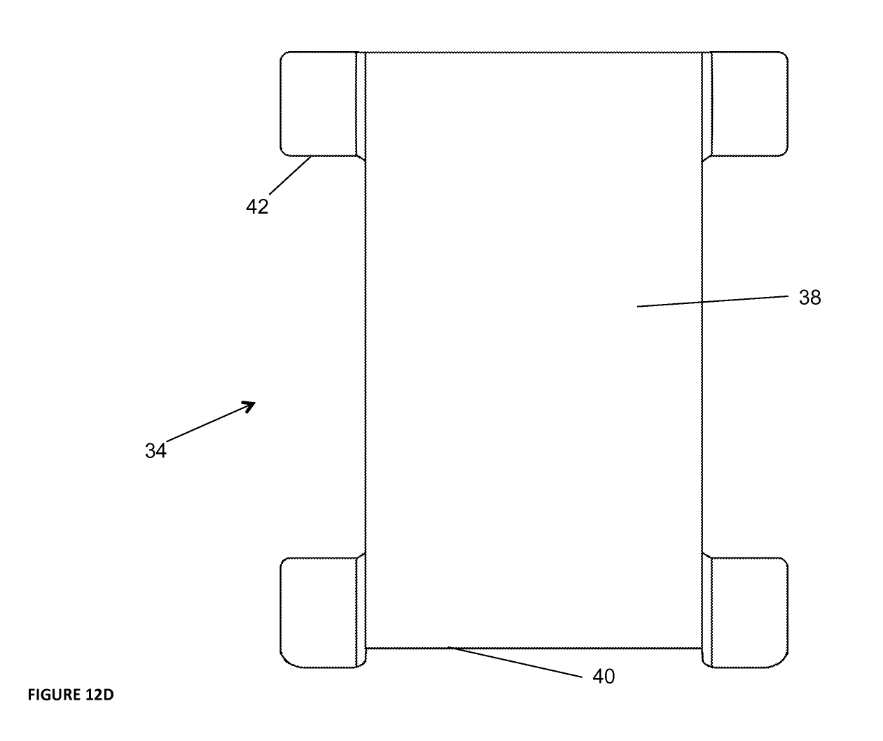

FIGS. 12A-12D are perspective views of a first embodiment of the invented body and arms structure 34. The first embodiment of the body and arms structure 34 includes a first wall 36, and a second wall 38 joined together by a base plate 40. The body is able to sit upright on the base plate 40. Between the first wall 36 and the second wall 38 is a cavity 41 which is configured to accept a portable media device and hold said device for storage. Affixed to the first wall 36 are arms 42. There would be an arm 42 attached to each former of the first wall 36. These arms 42 are configured to hold a portable media device 4 in place through by force friction, gripping elements 6 (not shown), or another suitable means known in the art. The body and arms structure 34 can be composed of hard plastic, ridged or malleable metal, or any other suitable material known in the art.

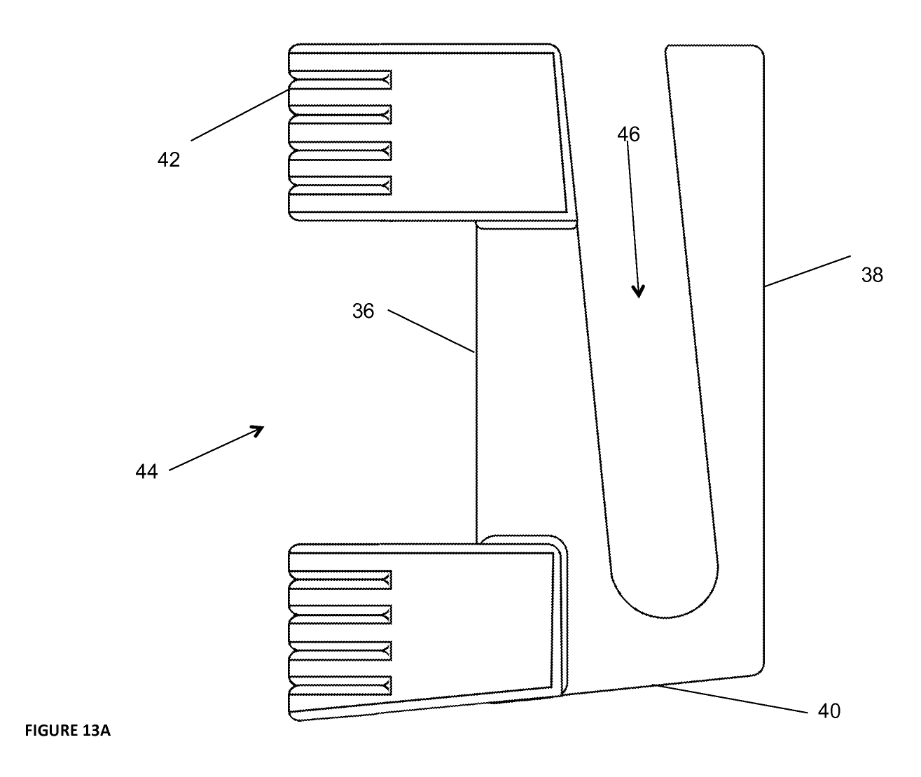

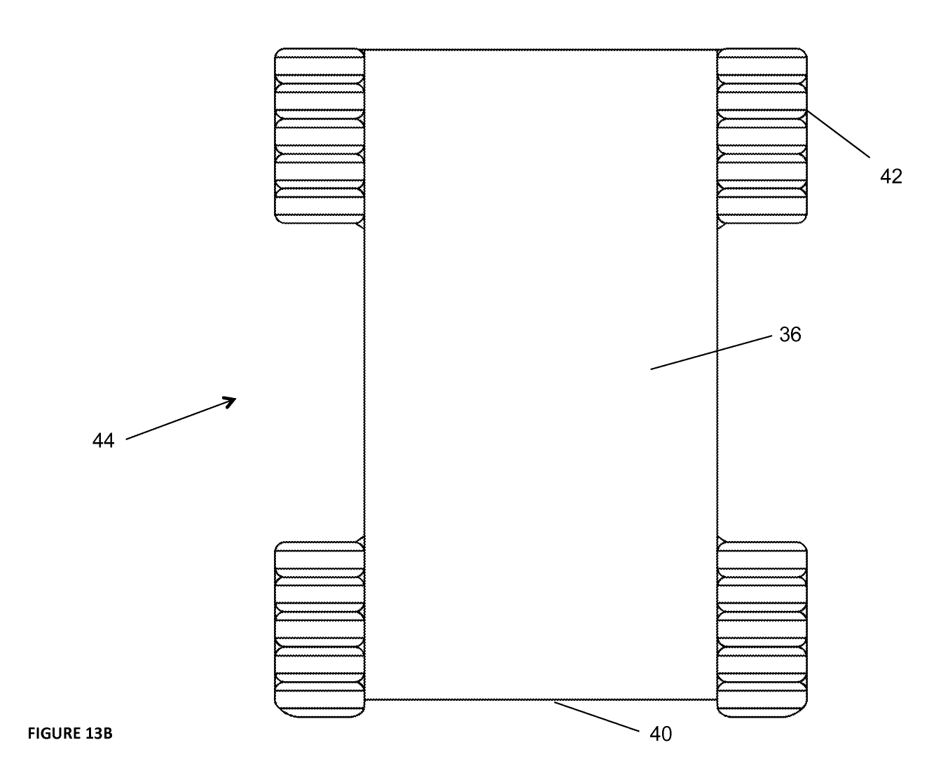

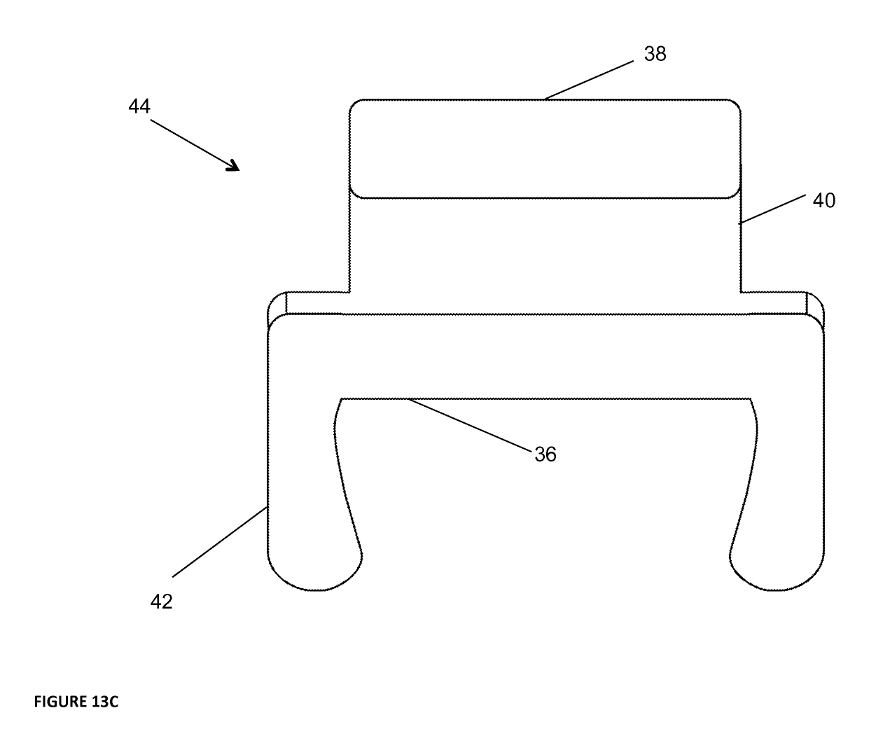

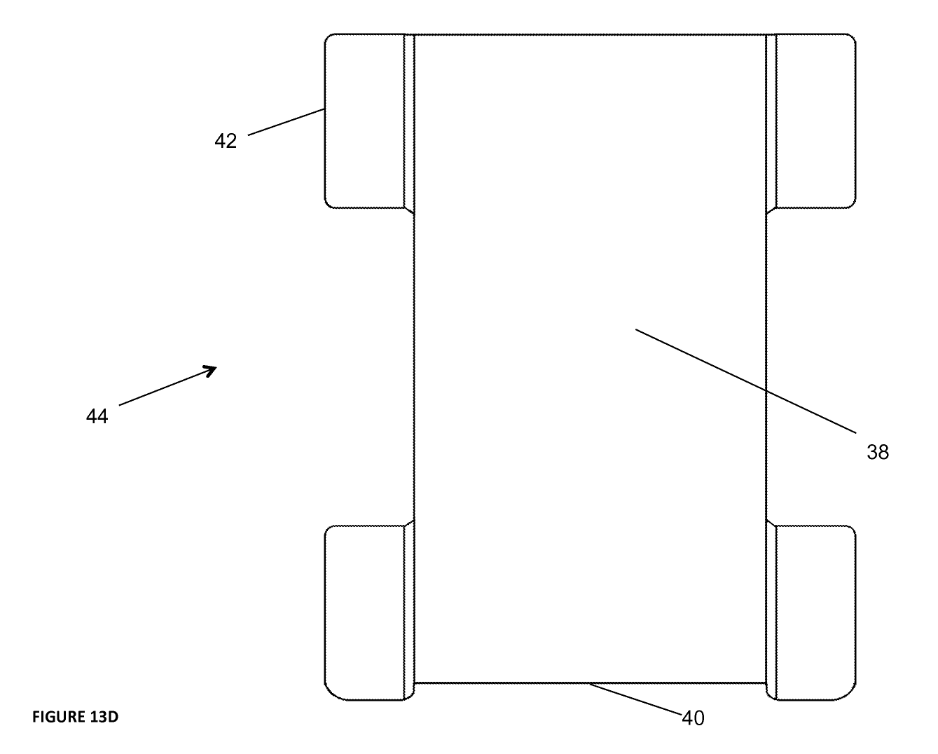

FIGS. 13A-13D are perspective views of a second embodiment of the invented body and arms structure 34. The second embodiment of the body and arms structure 44 includes a first wall 36, and a second wall 38 joined together by a base plate 40. The body is able to sit upright on the base plate 40. Between the first wall 36 and the second wall 38 is a slanted cavity 46 which is configured to accept a portable media device 4 and hold said device for storage. The slanted cavity 46 is shaped in a diagonal manner wherein a portable media device 4 placed in the slanted cavity 46 will rest up against the cavity side 36A of the first wall 36 thereby providing additional friction for the portable media device 4 and ease of placement and removal from the slanted cavity 46. Affixed to the first wall 36 are arms 42. There would be an arm 42 attached to each former of the first wall 36. These arms 42 are configured to hold a portable media device in place through by force friction, gripping elements 6 (not shown), or another suitable means known in the art. The body and arms structure 44 can be composed of hard plastic, ridged or malleable metal, or any other suitable material known in the art.

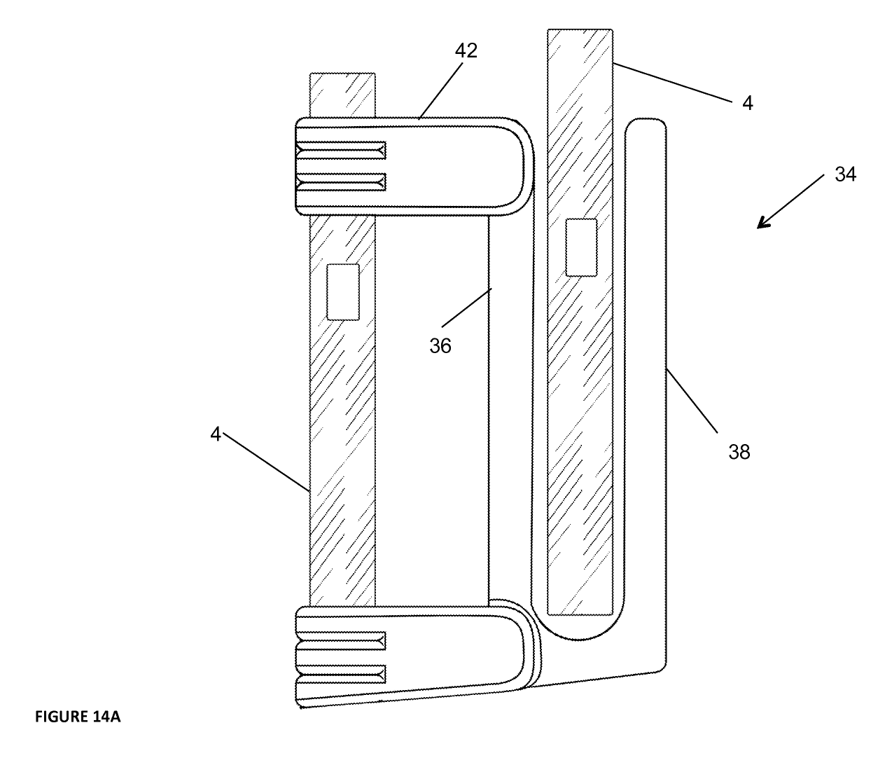

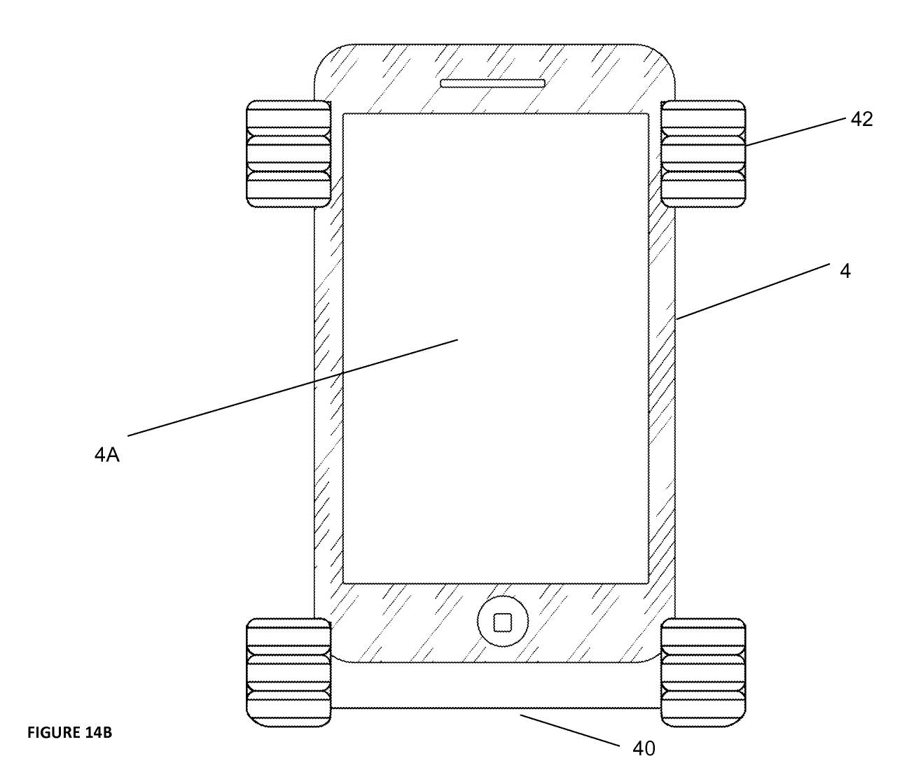

FIGS. 14A and 14B are side and front views of a first embodiment of the invented body and arms 34 both storing and displaying a portable media device 4. The cavity 41 between first wall 36 and second wall 38 is pictured containing a portable media device 4. Additionally a portable media device 4 is disposed between the four arms 42 of the first embodiment 34.

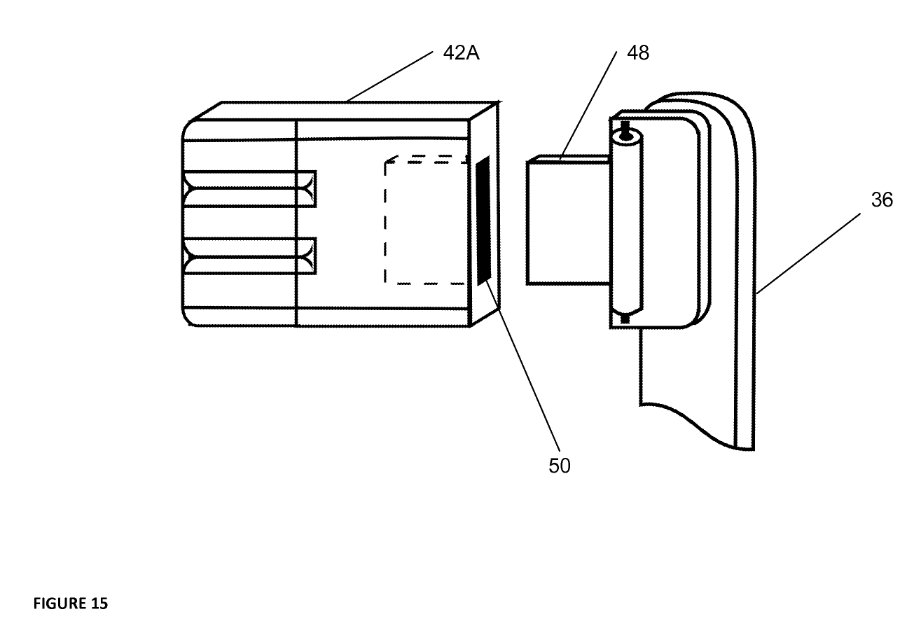

FIG. 15 is a close-up view of a removable arm of the invented body. The removable arm 42A would be affixed to the first wall 36 by means of a bracket 48. The bracket 48 would fit into an arm cavity 50. The bracket 48 would lock into place into the arm cavity 50 with a tab, force friction, or any other suitable method known in the art. Removal of an arm 42A would allow the present invention to use only two arms 42 to support the display or presentation of a portable media device. The removable arm 42a could be implemented into any of the embodiments of the invented body and arms which include arms 42.

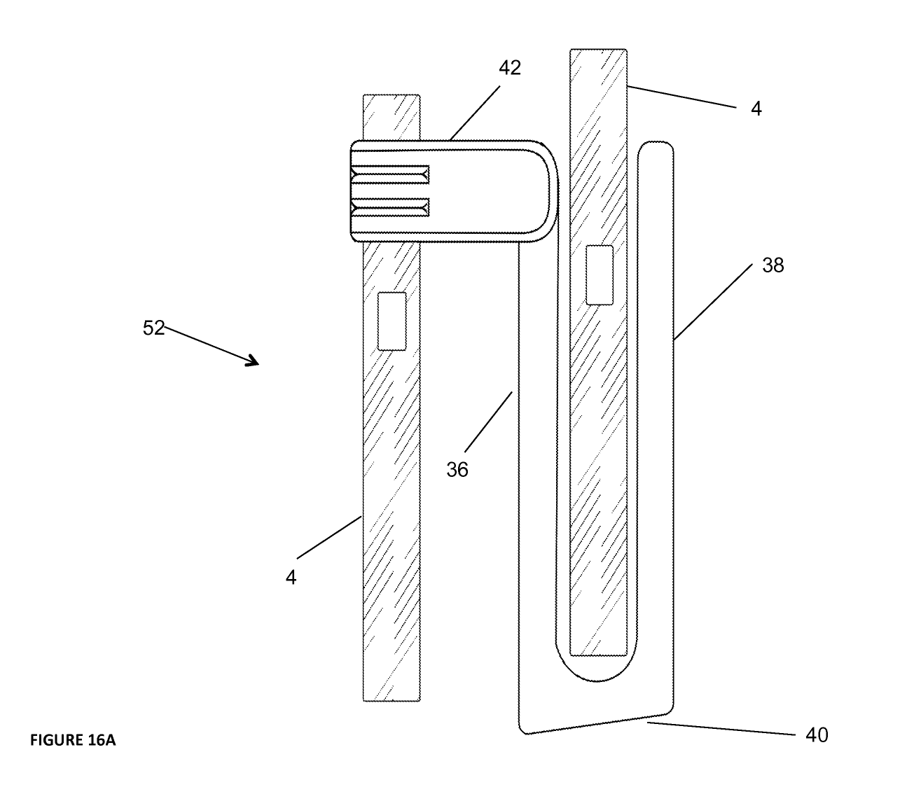

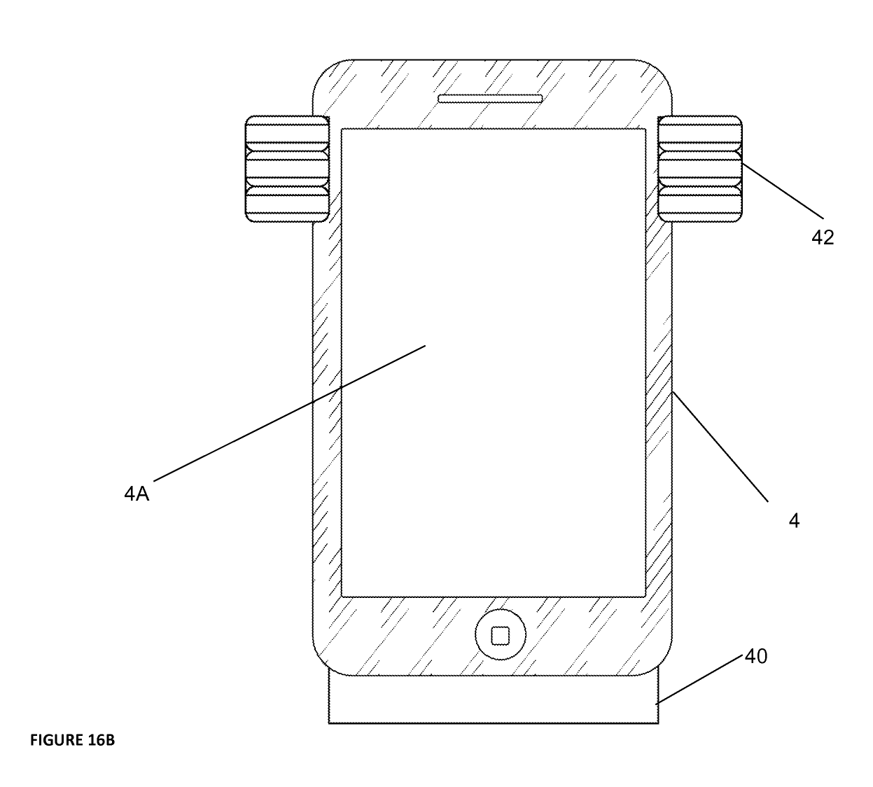

FIGS. 16A and 16B are side and front views of a third, two-arm embodiment 52 of the invented body and arms both storing and displaying a portable media device 4. The third embodiment of the invented body and arms 52 includes many of the parts of the previous embodiments 34, 44 such as a first wall 36 and a second wall 38, a base 40, and arms 42. However, the third embodiment 52 only includes two arms 42 to display a portable media device 4. FIG. 16 displays the pair of arms 42 at the top of the first wall 36, but these arms could be located at the base of the first wall 36 as well.

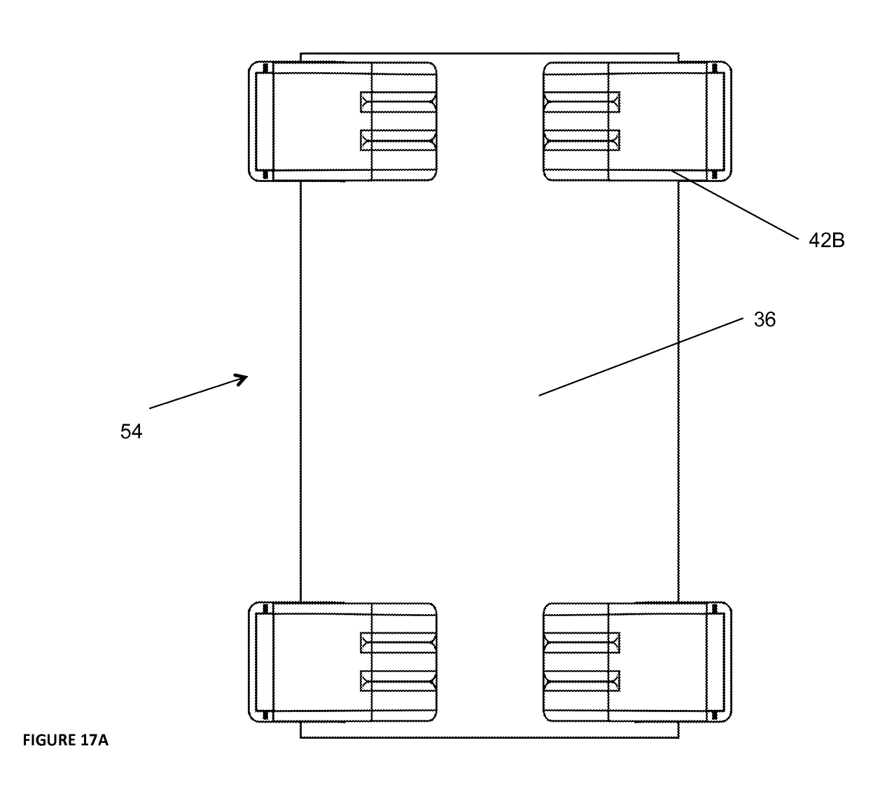

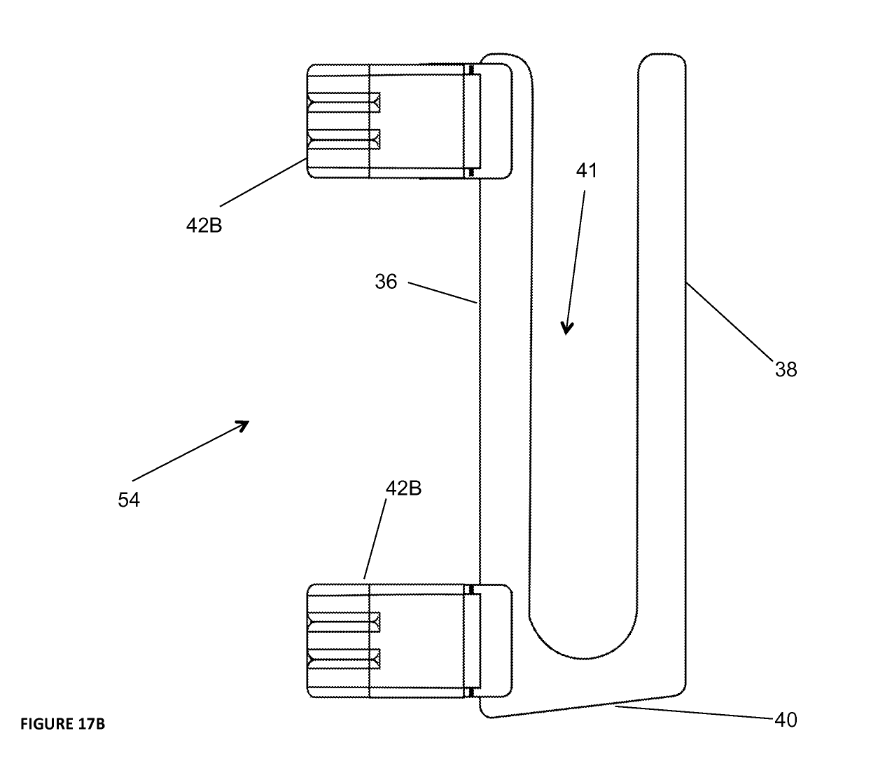

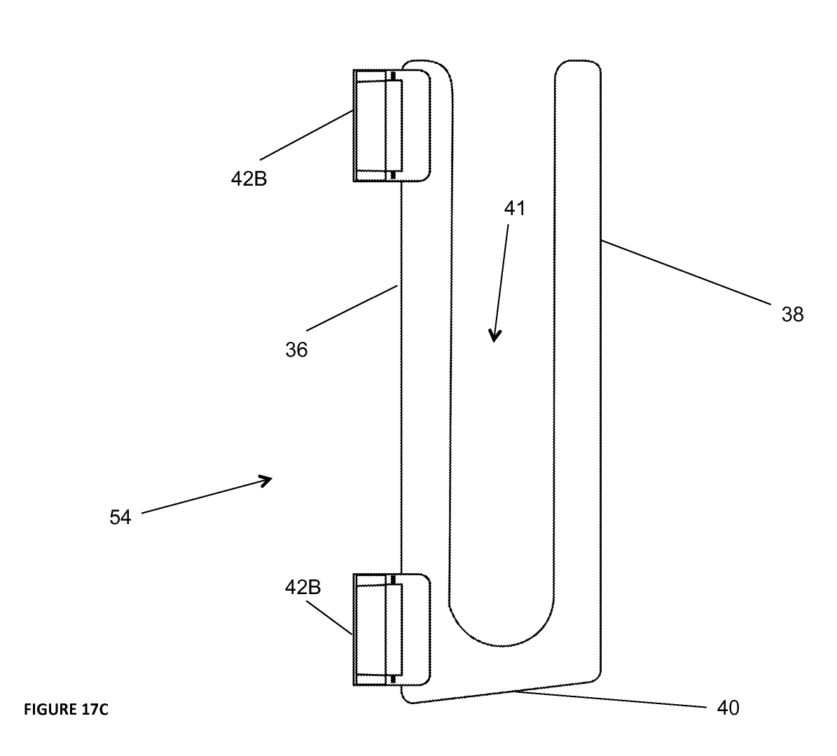

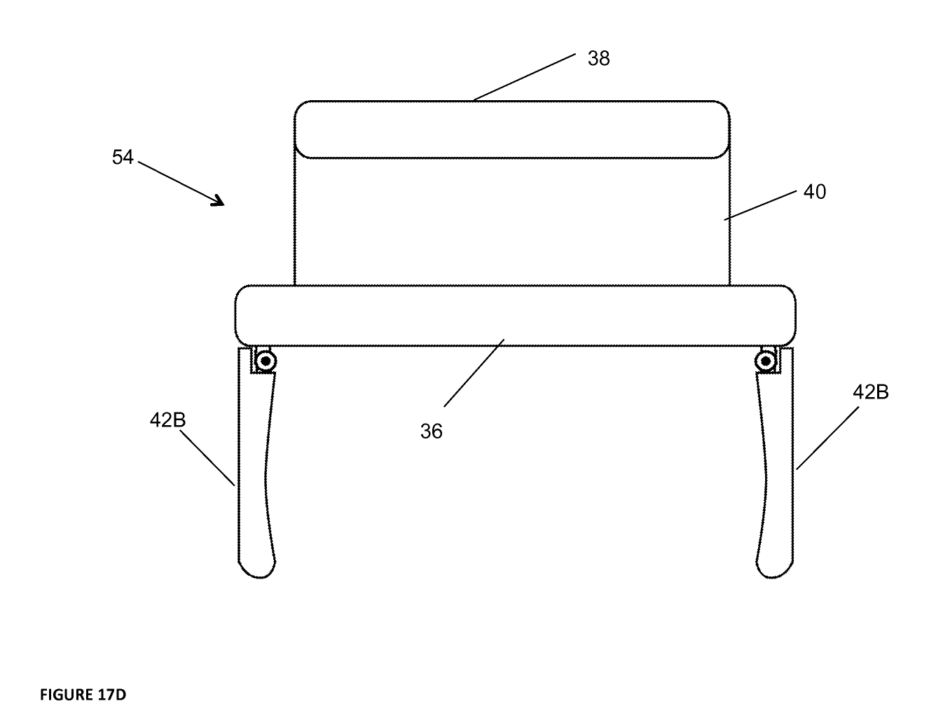

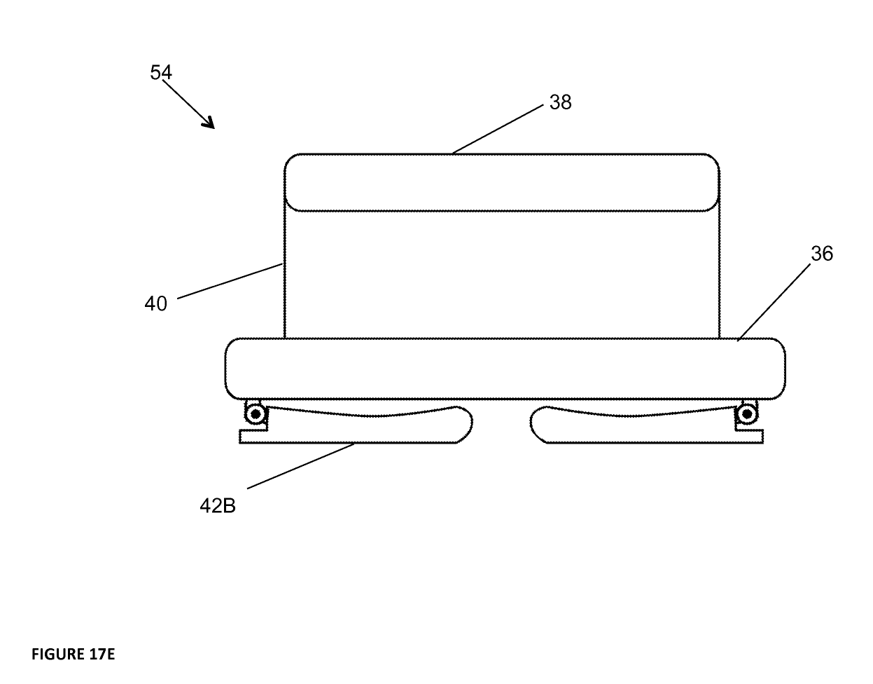

FIGS. 17A, 17B, 17C, and 17D are perspective views of a fourth embodiment 54 of the presently invented body and arms. The fourth embodiment 54 includes clamp arms 42B. The clamp arms 42B of the fourth embodiment 54 differ from the arms 42 of earlier embodiments in that said clamp arms 42B fold over in order to secure the portable media device 4 in place for display. The clamp arms 42B of the fourth embodiment could feasibly be made removable similarly to removable arm 42A or be combined with the slanted cavity 46 of the second embodiment 44.

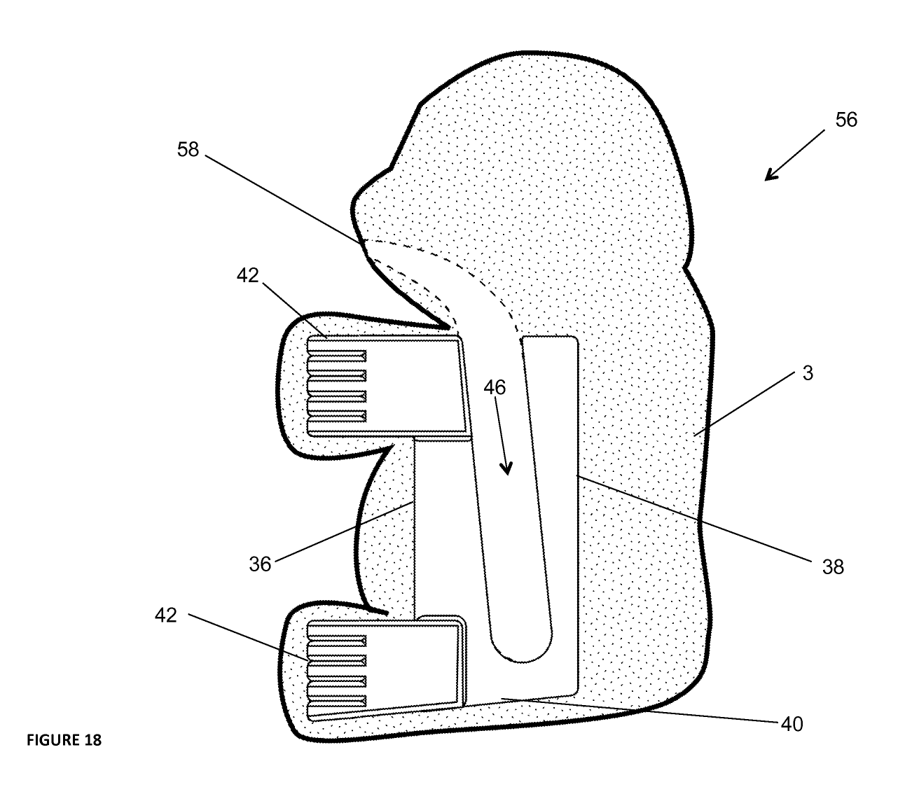

FIG. 18 is a side, cut-away view of a second embodiment of the invented toy. In the second embodiment of the invented toy 56 a second embodiment 44 of the invented body and arms and placed internally to a figurine 3. The arms 42 of the second embodiment 44 are within the arms of the figurine 3. Access to the slanted cavity 46 is achieved via a mouth aperture 58 in the figurine 3. The mouth aperture 58 would be large enough such that a portable media device 4 would be able to be placed inside it and an approximation of a human hand or fingers could fit in and pull the same portable media device 4 back out. The mouth aperture 58 is able to be sealed by a zipper, Velcro, spring, or any other suitable means known in the art. The pictured second embodiment of the invented toy 56 could additionally make use of elements of FIGS. 9 and 11 such as the weighted bag 30 or the carrying strap 32.

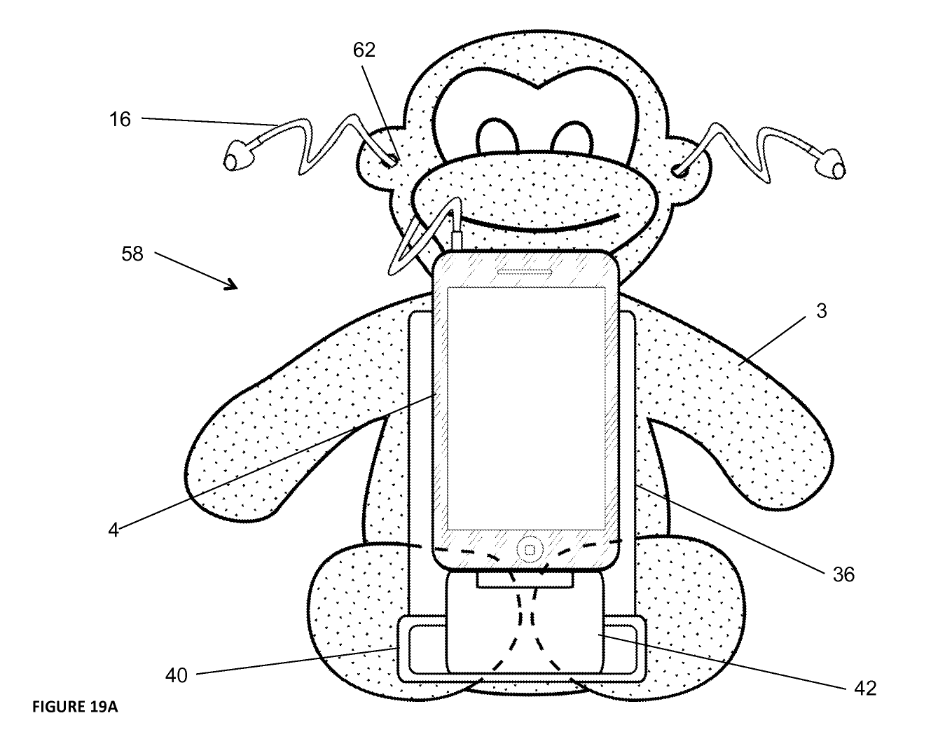

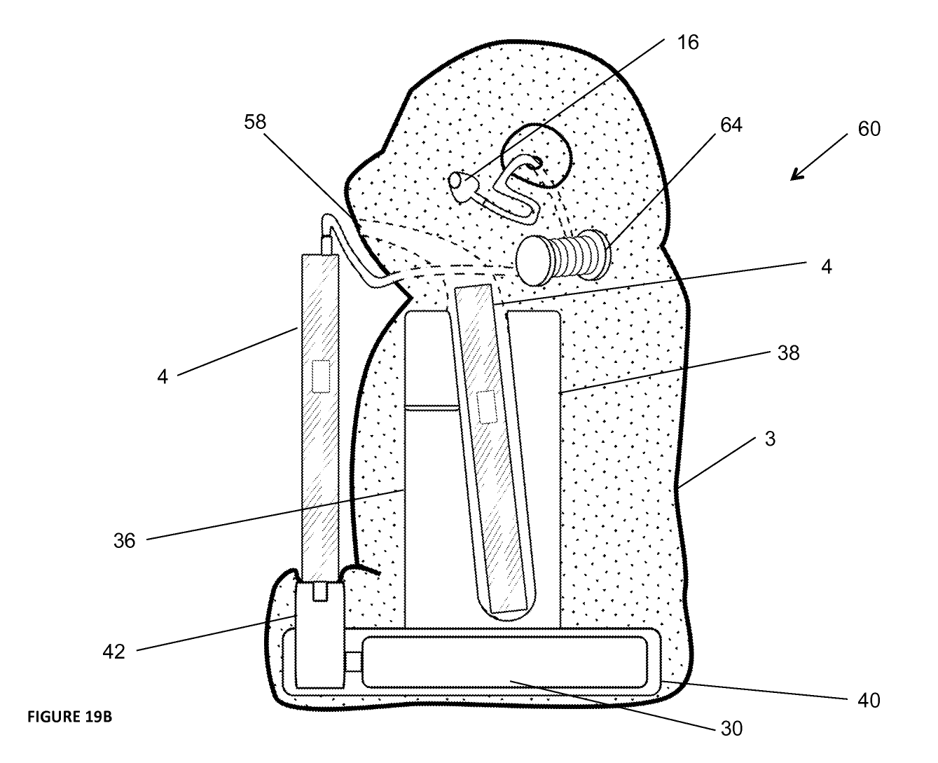

FIGS. 19A and 19B are front and side views of the third embodiment of the invented toy 60 including additional peripheral ear phones 16. The third embodiment of the invented toy 60 includes ear phones 16 which extend from ear apertures 62 of the figurine 3. These ear phones 16 affix to the portable media device 4 and allow a user to listen to media privately. Inside the figurine 3 is an ear phone spool 64 which allows for the extension and retraction of the ear phones 16. In this third embodiment of the invented toy 60, two arms 42 are utilized to display the portable media device 4 and the arms are affixed to the base 40 as opposed to the first wall 36.

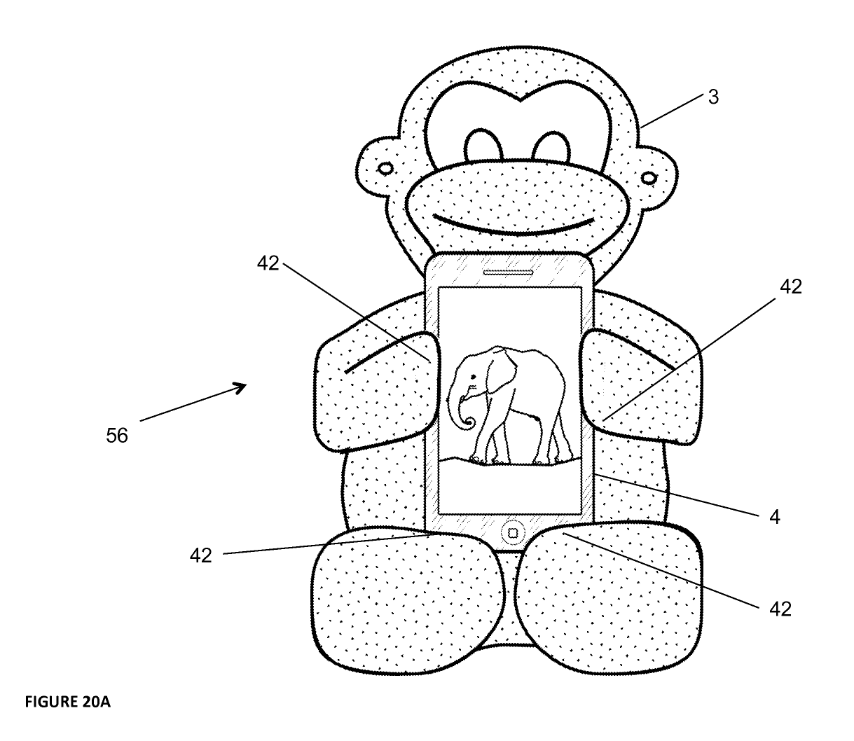

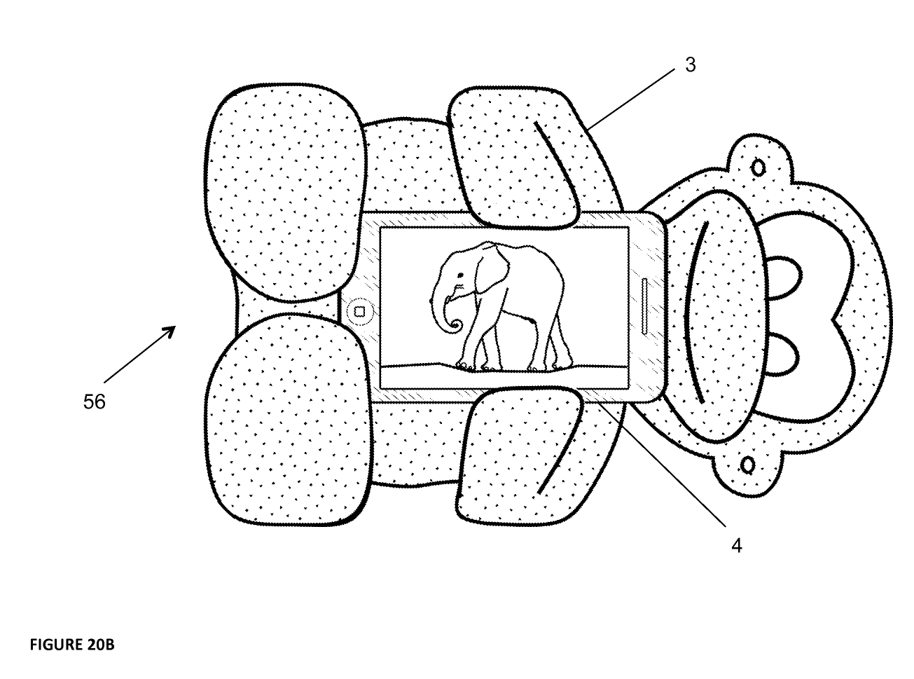

FIGS. 20A and 20B are orientation views of a second embodiment of the invented toy 56 utilizing four arms 42 to display a portable media device 4. The figurine 3 may be positioned in both an upright and a horizontal orientation according to the preferred display orientation of the user.

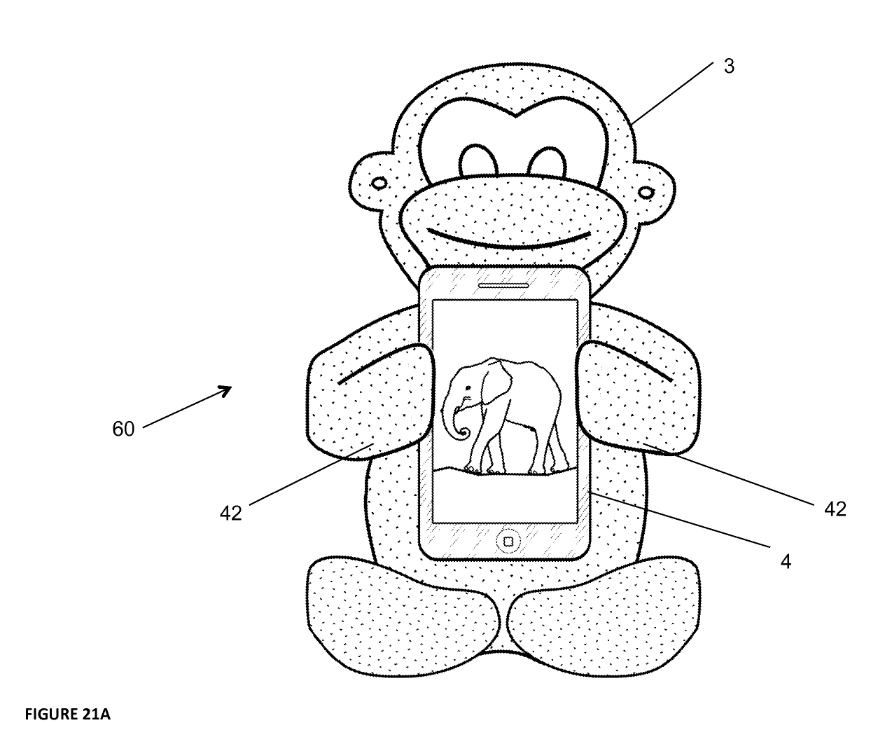

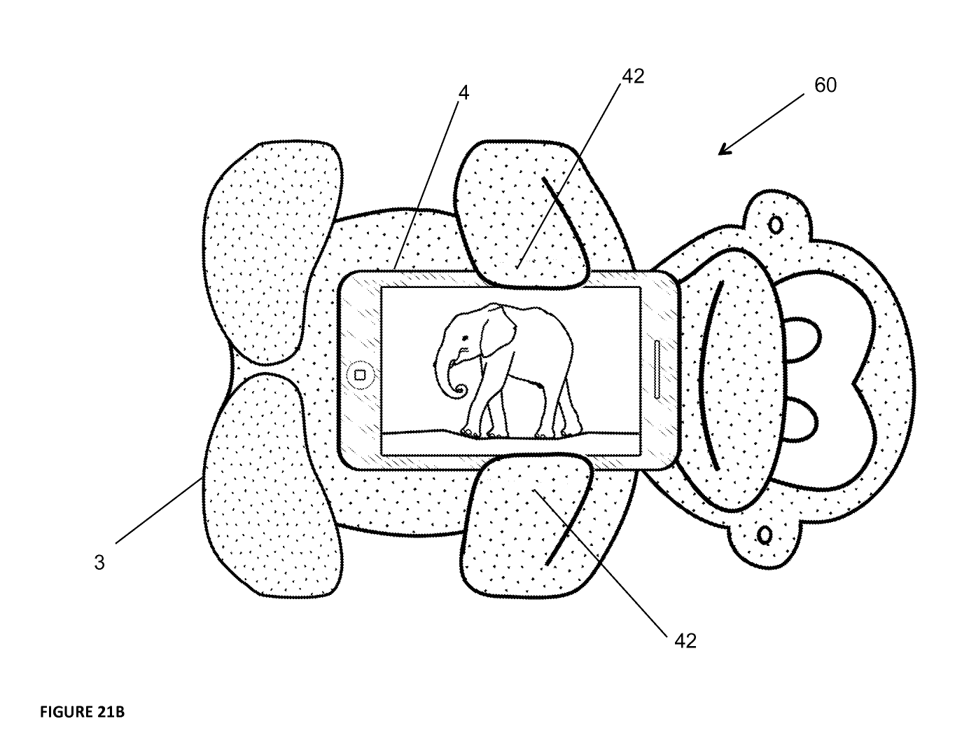

FIGS. 21A and 21B are orientation views of a third embodiment of the invented toy 60 utilizing two arms 42 to display a portable media device 4. The figurine 3 may be positioned in both an upright and a horizontal orientation according to the preferred display orientation of the user. Previous figures have shown the third embodiment of the invented toy 60 utilizing two arms 42 at the base of the toy 60; here, the arms 42 are pictured at the top of the toy 60. FIG. 21 is provided for illustrative purposes demonstrating the use of two arms 42 used in a horizontal orientation and should not be viewed as limiting on any particular embodiment.

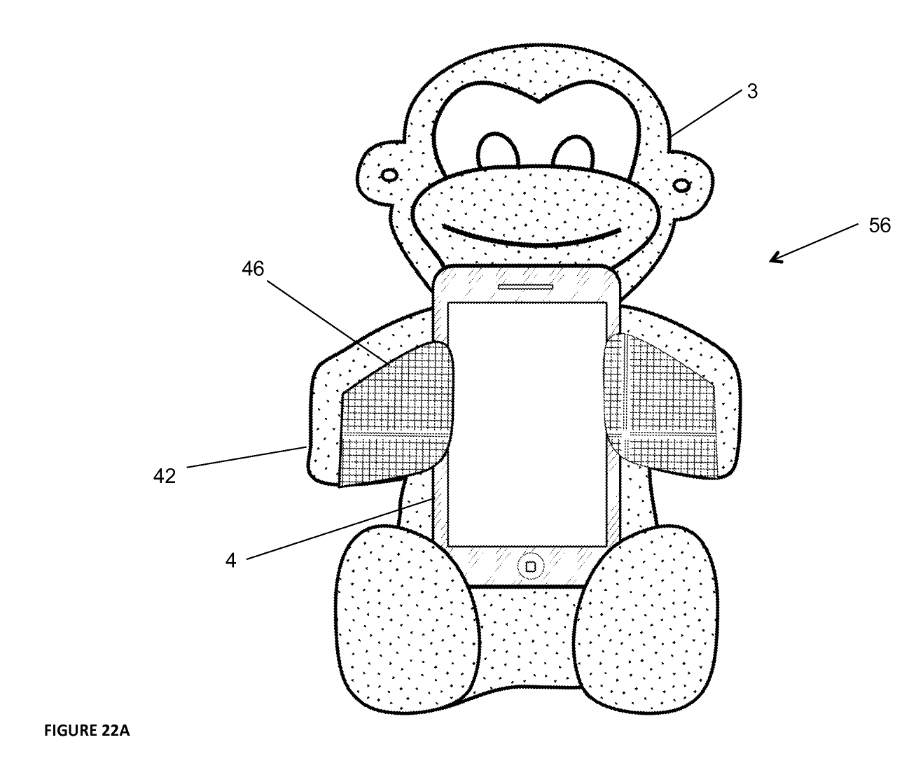

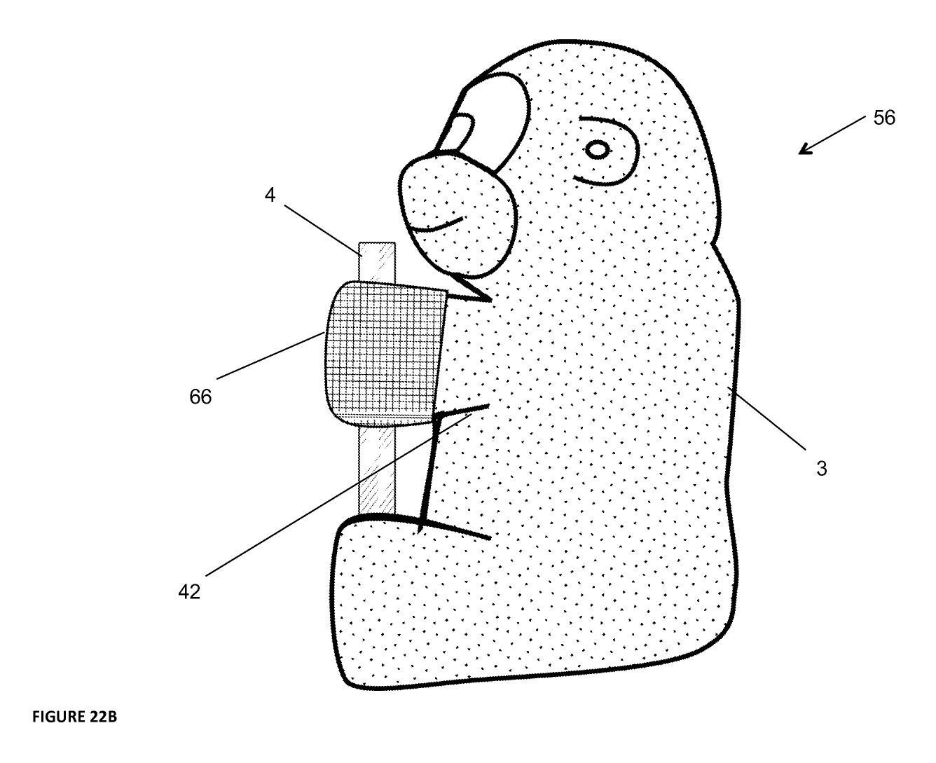

FIGS. 22A and 22B are front and side views of the invented toy including customizable, arm mittens 66. Attached to a figurine's 3 arms 42 a user can apply customizable mittens 66 which provide and additional aesthetic appeal and personalization to the invented toy 56.

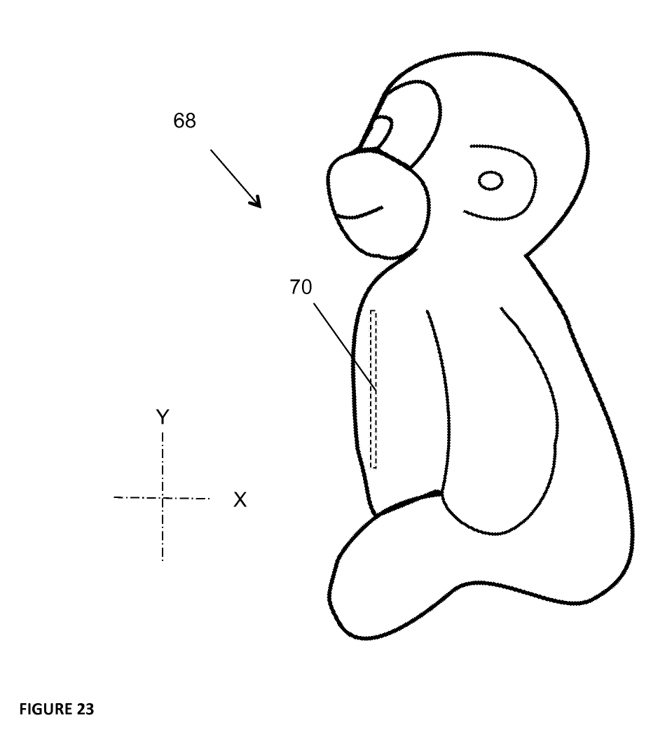

FIG. 23 is a side view of an alternate plush toy 68 that encapsulates a magnetic plate 70.

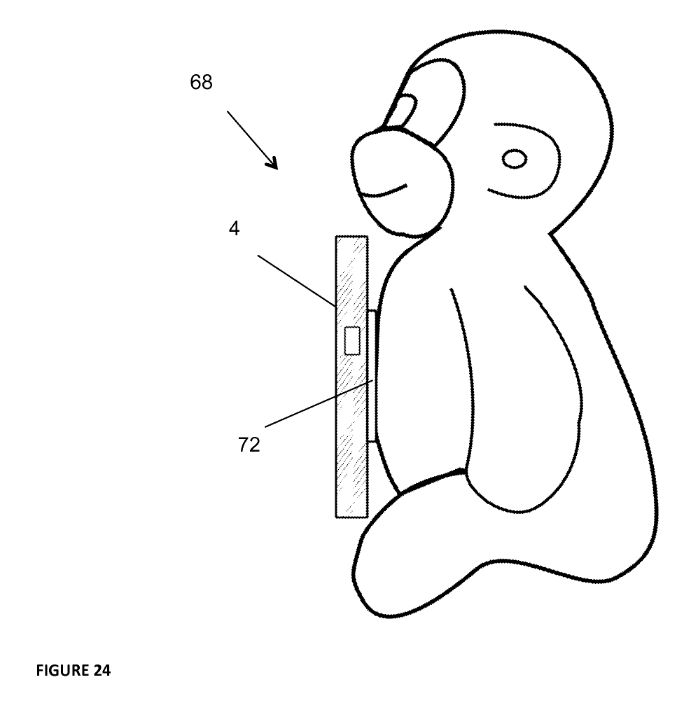

FIG. 24 is a side view of the alternate plush toy 68 showing the phone 4, wherein a ferromagnetic material assembly 72 is affixed to the phone 4 and the phone 4 in combination with the ferromagnetic material assembly 72 is pulled toward the magnetic plate 70 by magnetic attraction between the ferromagnetic material assembly 72 and the magnetic plate 70.

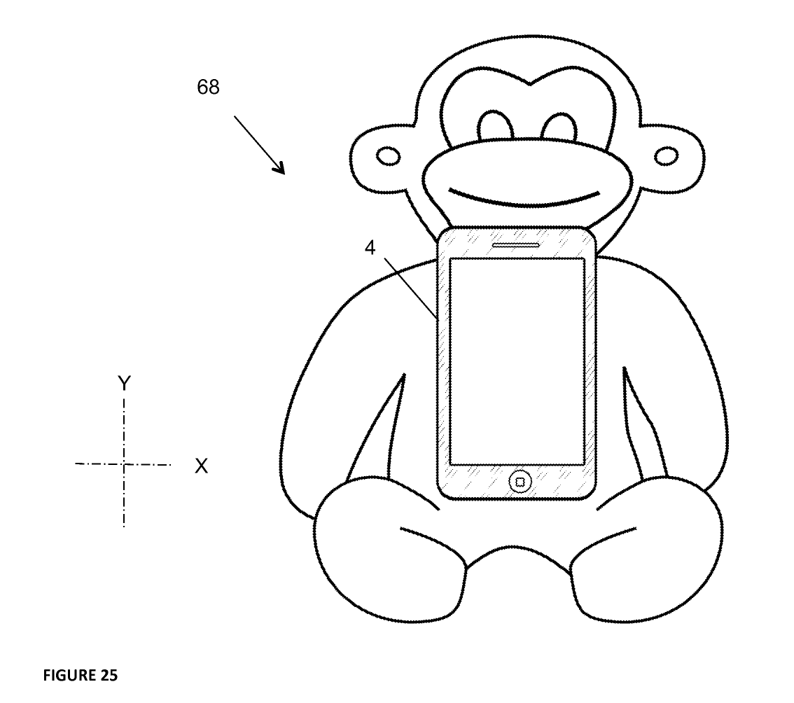

FIG. 25 is a front view of the phone 4 and alternate plush toy 68 of FIG. 24 the phone 4 is attached to ferromagnetic material assembly 72, and the phone 4 in combination with the ferromagnetic material assembly 72 is pulled toward the magnetic plate 70 by magnetic force, as also shown in FIG. 24. FIG. 25 includes a presentation of two mutually orthogonal axes, namely a vertical Y axis and an X axis of a horizontal plane.

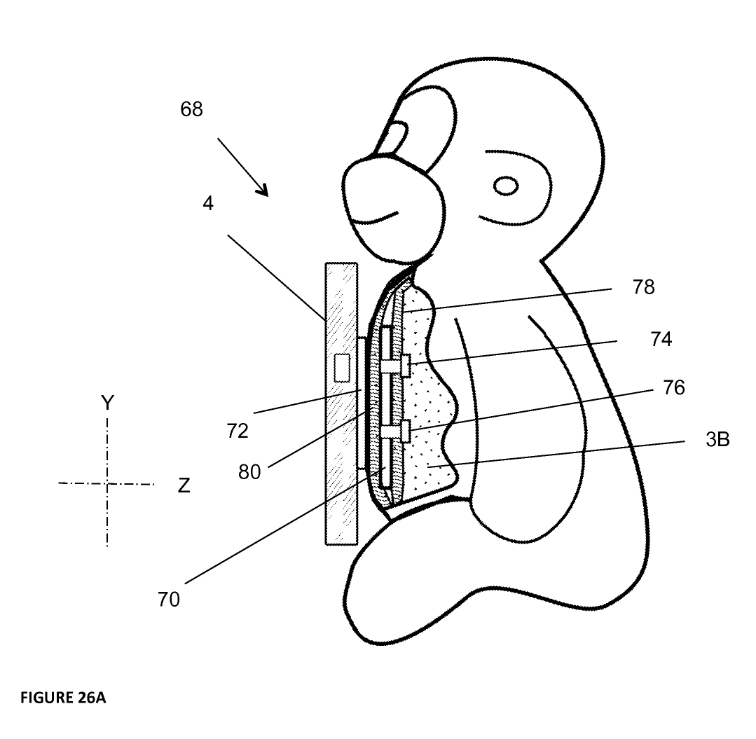

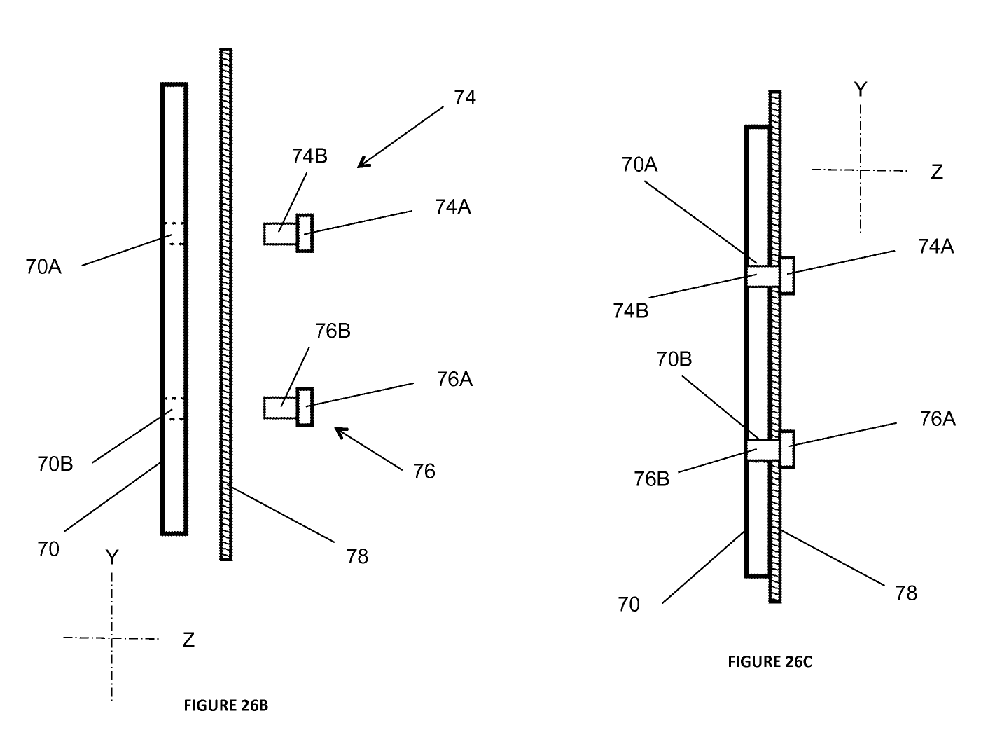

FIG. 26A is a cut-away side view of the alternate plush toy 68 and showing the phone 4 in combination with the ferromagnetic material assembly 72 being pulled toward the magnetic plate 70 by magnetic attraction between the ferromagnetic material assembly 72 and the magnetic plate 70. For clarity of explanation FIG. 26A includes a presentation of two mutually orthogonal axes, namely the vertical Y axis and an Y axis of the same horizontal plane referred to regarding the X axis of FIG. 25.

FIG. 26B is a detailed exploded view of the magnetic plate 70, two fasteners 74 & 76 and an internal section of fabric 78. The magnetic plate 70 includes a pair of circular apertures 70A & 70B that each extend fully through the magnetic plate 70.

The three mutually orthogonal axes X axis, Y axis and Z axis will be used in the following explanation of FIGS. 26B and 26C.

The first fastener 74 includes a first cap 74A and a first shaft 74B. The second fastener 76 includes a second cap 76A and a second shaft 74B. Each shaft 74B & 76B is preferably circular in a cross section within a Y-Z plane that extends along both the Y-axis and the Z axis. The Y-Z diameter of each shaft 74B & 76B is preferably over-sized within 0.001 inch to 0.01 inch in relation to each of the plate circular apertures 70A & 70B whereby a friction fit is formed when each shaft is 74B & 76B is separately forced into a different circular aperture 70A & 70B. The forcing of each shaft 74B & 76B into a different circular aperture 70A & 70B may be accomplished by manual application of a hammer (not shown), wherein an internal fabric 78 is pierced at separate locations by each shaft 74B & 76B.

The section of internal fabric 78 is preferably a durable and rugged fabric, such as nylon, canvas or other suitable organic or inorganic fabric known in the art. The section of internal fabric 78 preferably presents a continuous thickness within the horizontal plane defined by the mutually orthogonal X axis and Z axis.in the range of from one millimeter to five millimeters.

FIG. 26C is a detailed cut-away view of the of the magnetic plate 70 and the section of internal fabric 78 coupled by the two fasteners 74 & 76 of FIG. 26A piercing through the fabric 78 and forming a friction fit with the magnetic plate 70.

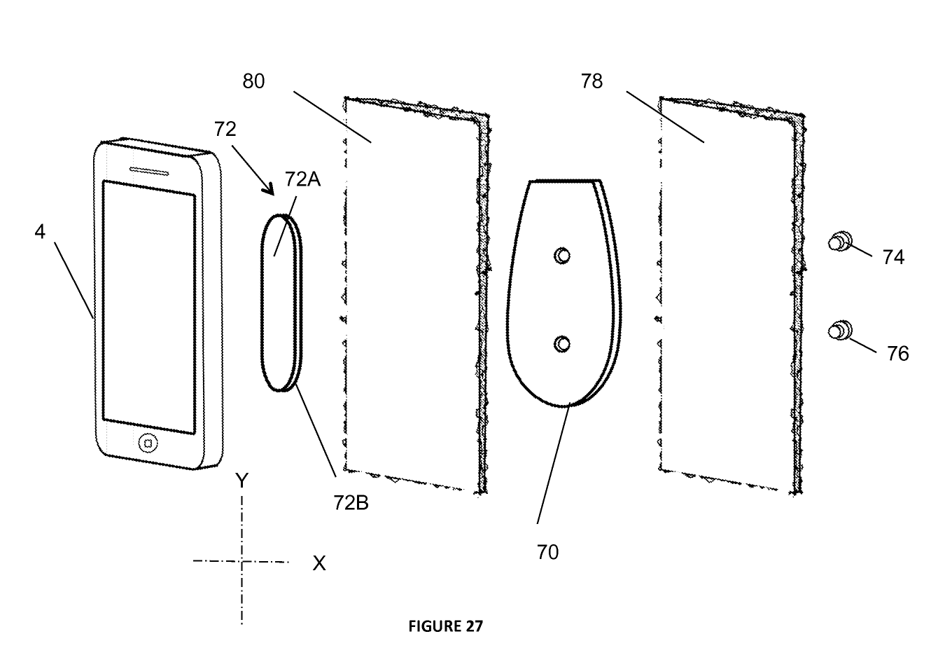

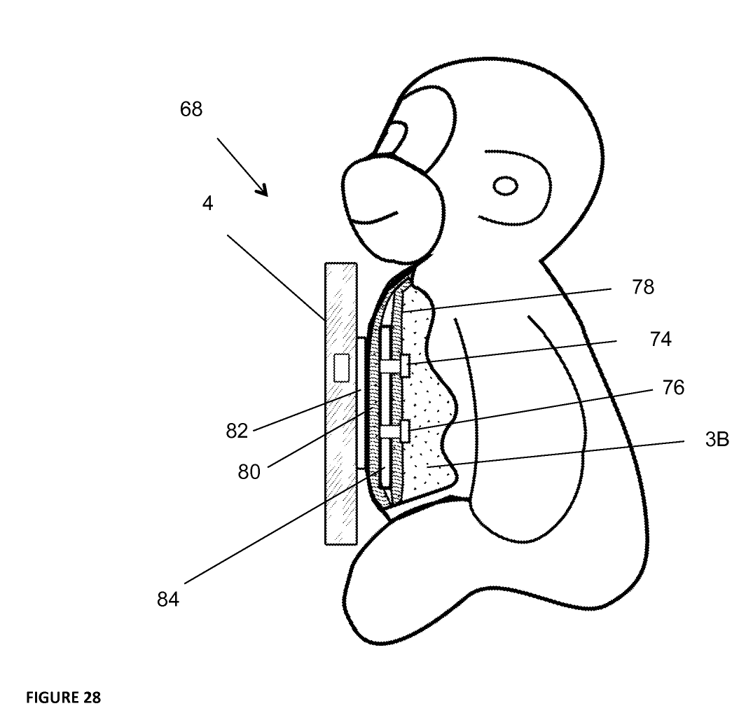

FIG. 27 is an exploded view perspective view of the phone 4, the magnetic plate 70, the two fasteners 74 & 76, the internal section of fabric 78, an external section of fabric 80 and the ferromagnetic material assembly 72. The ferromagnetic material assembly 72 includes an adhesive layer 72A positioned proximate to the phone 4 a ferromagnetic material layer 72B. The adhesive 72A is selected, configured, positioned and applied to adhere the ferromagnetic material layer 72B to the phone 4.

The dimensions of the ferromagnetic material assembly 72 is preferably at least 0.25 inch smaller than the phone 4 in each dimension of the vertical Y axis and the horizontal Z axis. The adhesive material 72A may be a suitable adhesive material known in the art, such as the adhesive comprised within metal plate component of the MAGICMOUNT SURFACE™ magnetic mounting product adapted for cell phones as marketed by Scosche Industries of Oxnard, Calif. In addition, the ferromagnetic material layer 72B of the ferromagnetic material assembly 72 may be a suitable ferromagnetic material known in the art, such as the comprised within metal plate component of the MAGICMOUNT SURFACE™ magnetic mounting product adapted for cell phones as marketed by Scosche Industries of Oxnard, Calif.

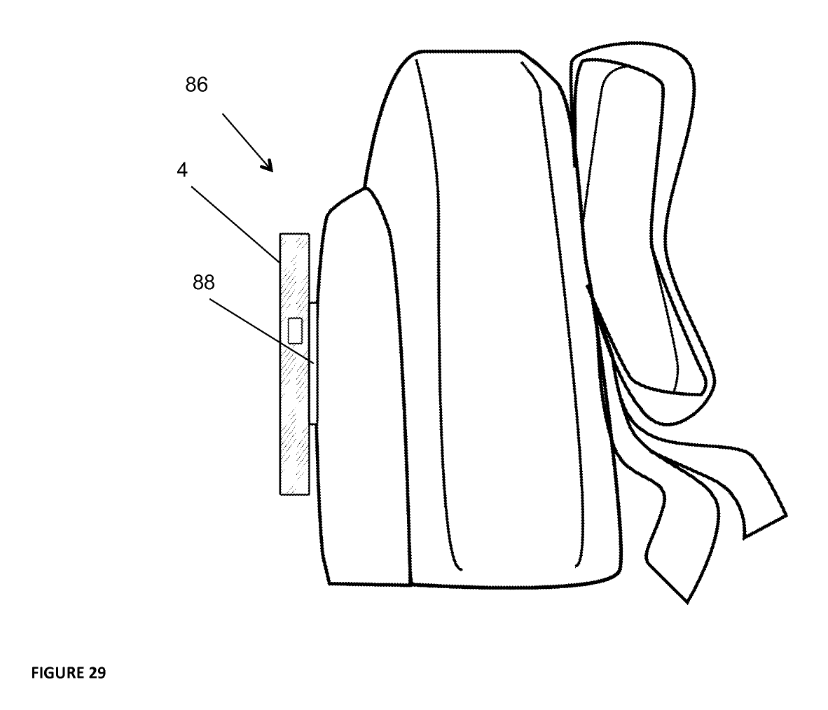

FIG. 28 is a cut-away side view an alternate variation of the present, wherein an alternate magnetic plate 82 is adhered to the phone 4 and the alternate plush toy 68 encapsulates an alternate material 84, wherein the alternate material 84 may be ferromagnetic and/or hold a charge that is attractive to the alternate magnetic plate 82. The adhesive 72A is also selected, configured, positioned and applied to the alternate magnetic plate 82 to adhere the alternate magnetic plate 82 to the phone 4. An optional stuffing material is preferably less than 0.5 inch in thickness along the X-axis.

FIG. 29 is a side view of a backpack 86 coupled with components of FIG. 27 and/or FIG. 28. Element 88 may be either the ferromagnetic material assembly 72 or the alternate magnetic plate 82 in alternate embodiments of the present invention.

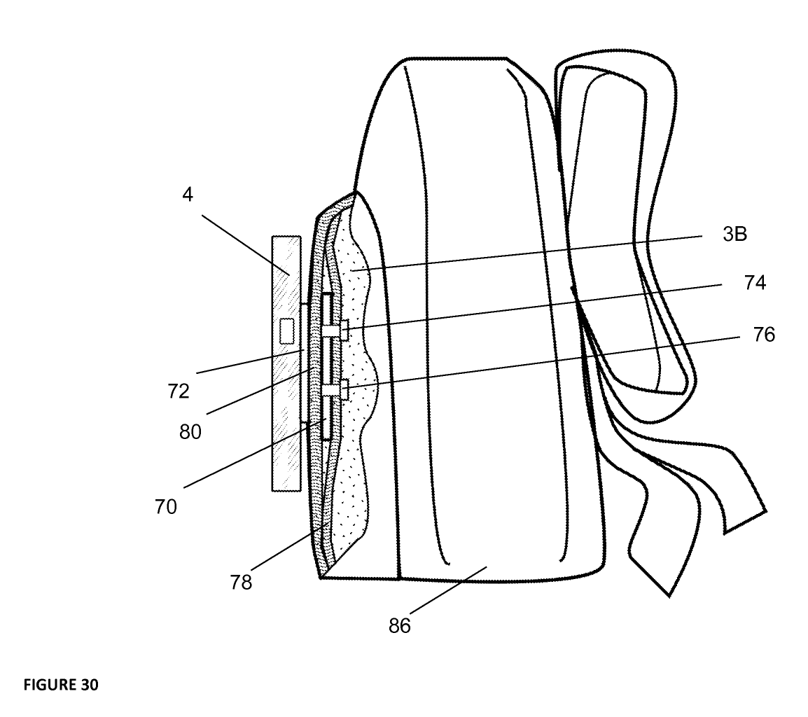

FIG. 30 is a cut-away side view of the backpack 86 coupled with components of FIG. 27.

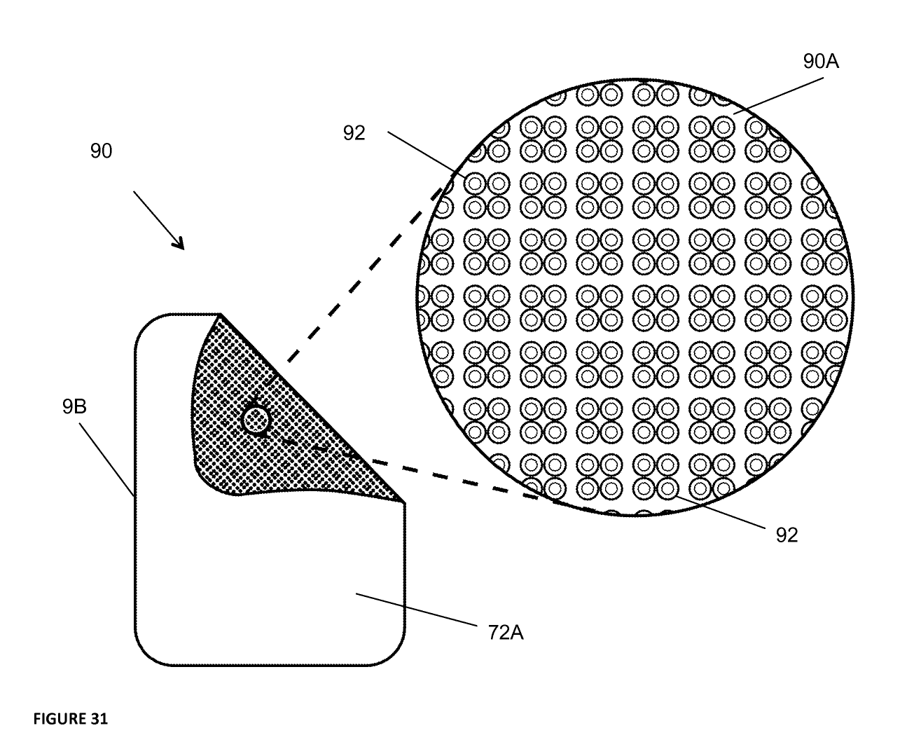

FIG. 31 is a detailed view of a sheet of nanosuction material 90 that includes a plurality or multiplicity of nanosuction features 92 as exposed on a front side 90A of the of nanosuction material 90. The adhesive 72A may be applied to a back side 90B of the nanosuction material 90. The adhesive 72A is selected, configured, positioned and applied to adhere the nanosuction material 90 to the phone 4. The nanosuction material 90 may be or comprise a suitable suction or nanosuction material known in the art, such as the gripping surface structure of the EVERSTICK NANOSUCTION™ nanosuction material as marketed by UM! BRANDS of Chino, Calif.

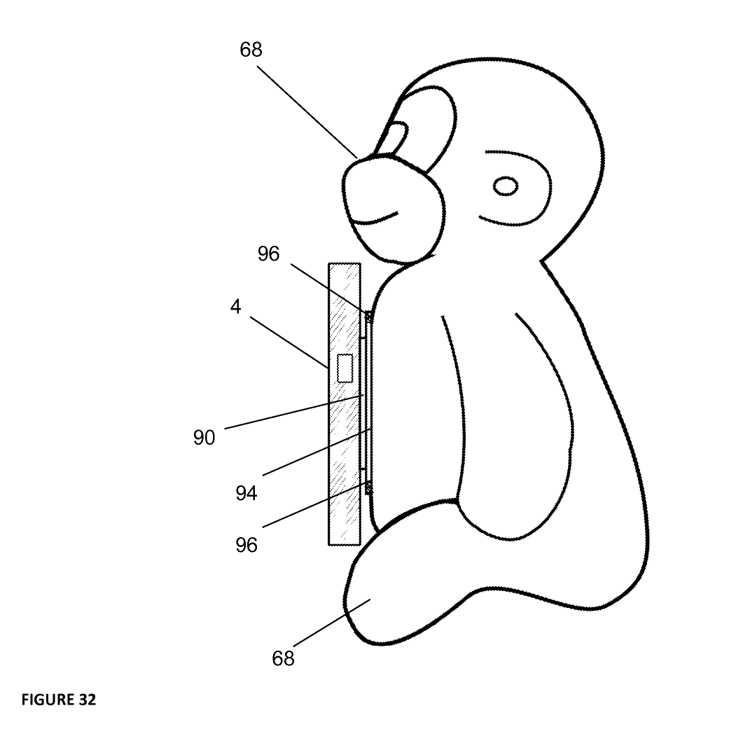

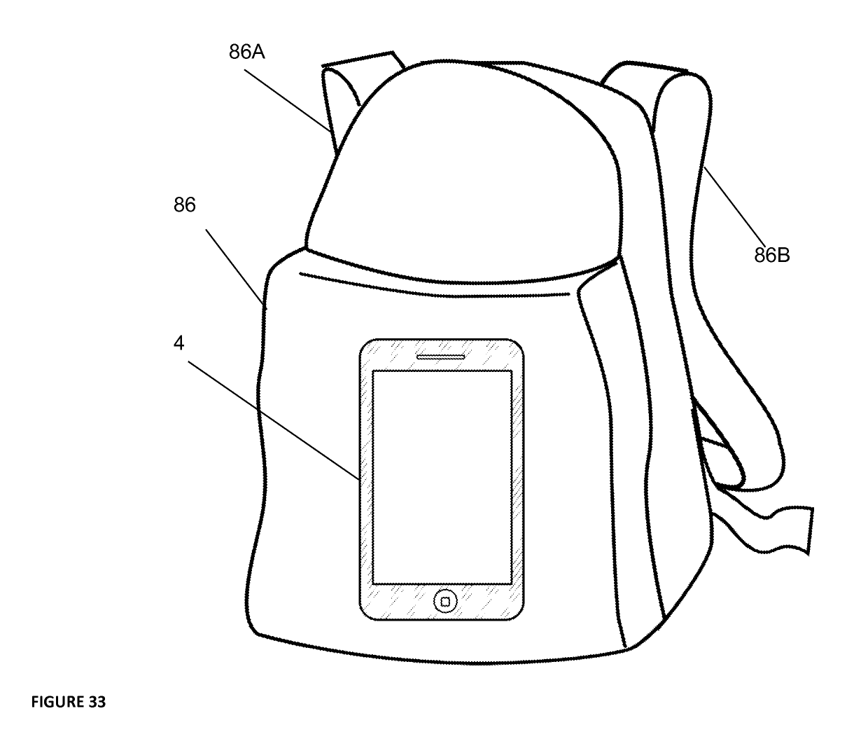

FIG. 32 is a side view of the nanosuction material 90 adhered to the phone 4 and removably coupled to a modification of the back pack 86. A flat plate 94 is coupled to the alterante plush toy 68 by attachment features 96. The flat plate 94 is shaped and positioned to enable a suction fit with the nanosuction features 92, whereby the phone 4 is removably coupled with the alternate plush toy 68.

FIG. 33 is a perspective front view of the backpack of FIG. 32 removably coupled with the phone 4. Each of two shoulder straps 86A & 86B of the back pack 86 may be used to position the back pack 86 on the user's torso.

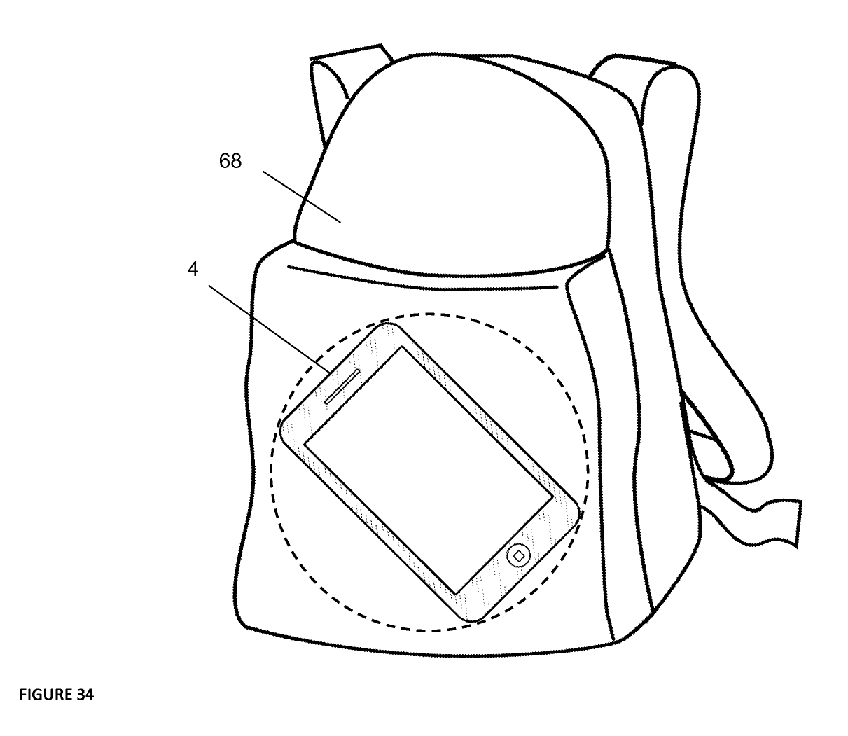

FIG. 34 is a perspective front view of the backpack 86 and removably coupled with the phone 4 and indicating the range of positions possible in removably coupling the phone with the backpack as made possible by each of the preferred embodiments of the present invention of FIGS. 28, 29 and 32.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible configurations or aspects of the Present Invention. The examples given should only be interpreted as illustrations of some of the preferred configurations or aspects of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

We claim:

1. An article of manufacture for detachable coupling with a portable electronic device, the article of manufacture comprising:
a body, the body comprising a base, a first wall and a second wall, the first wall and the second wall extending from the base and forming a cavity, the cavity sized and shaped to receive the portable electronic device; and
at least two arms, the two arms extending from the body and substantively away from the cavity, the at least two arms adapted to contemporaneously detachably couple with the portable electronic device, whereby the portable electronic device is alternatively housed in the cavity or stabilized by the two arms and the body.

2. The article of manufacture of claim 1, wherein the body and the at least two arms are comprised within a unitary structure.

3. The article of manufacture of claim 1, wherein the at least two arms extend from the first wall and away from the cavity.

4. The article of manufacture of claim 1, wherein the at least two arms extend from the base.

5. The article of manufacture of claim 1, wherein at least one of the at least two arms is hingeably connected to the body, whereby the at least one of the at least two arms is rotationally postionable in relation to the first wall.

6. The article of manufacture of claim 1, further comprising a third arm, the third arm extending from the body and adapted to detachably couple with the portable electronic device contemporaneously with a detachable coupling of the portable electronic device with the at least two arms.

7. The article of manufacture of claim 5, further comprising a fourth arm, the fourth arm extending from the body and adapted to detachably couple with the portable electronic device contemporaneously with a detachable coupling of the portable electronic device with the at least two arms and the third arm.

8. The article of manufacture of claim 6, wherein the body and the third arm and the fourth arm are comprised within a unitary structure.

9. The article of manufacture of claim 6, wherein the third arm and the fourth arm extend from the first wall and substantively away from the cavity.

10. The article of manufacture of claim 6, wherein the third arm and the fourth arm extend from the base.

11. The article of manufacture of claim 1, further comprising a coupling mitten, the coupling mitten adapted for detachable coupling with at least one arm contemporaneous with detachable coupling with the portable electronic device, whereby the coupling mitten is disposed between the at least one arm and the portable electronic device.

12. An apparatus for positioning a portable electronic device comprising:
a fabric structure;
a magnetic plate coupled with the fabric structure; and
a ferromagnetic material adhered to the portable electronic device, whereby the ferromagnetic material is magnetically attracted to the magnetic plate and whereby the portable electronic device is removably coupled to the fabric structure.

13. The apparatus of claim 12, wherein the fabric structure comprises a plush toy.

14. The apparatus of claim 12, wherein the fabric structure comprises a back pack.

15. The apparatus of claim 12, wherein the ferromagnetic material carries a magnetic charge attractive to the magnetic plate.

16. The apparatus of claim 15, wherein the fabric structure comprises a plush toy.

17. The apparatus of claim 16, wherein the fabric structure comprises a back pack.

18. An apparatus for positioning a portable electronic device comprising:
a fabric structure;
a ferromagnetic material coupled with the fabric structure; and
a magnetic plate adhered to the portable electronic device, whereby the magnetic plate is magnetically attracted to the ferromagnetic material and whereby the portable electronic device is removably coupled to the fabric structure.

19. The apparatus of claim 18, wherein the fabric structure comprises a plush toy.

20. The apparatus of claim 18, wherein the fabric structure comprises a back pack.
